(19) United States
(12) Patent Application Publication
(10) Pub. No.: US 2026/0109486 A1
(43) Pub. Date: Apr. 23, 2026

(54) Apparatus and Method for Generating Propulsion Forces

(71) Applicant: Ian Clague, Bournemouth (GB)

(72) Inventor: Ian Clague, Bournemouth (GB)

(21) Appl. No.: 19/425,680

(22) Filed: Dec. 18, 2025

Related U.S. Application Data
(63) Continuation-in-part of application No. 18/549,627, now abandoned.

(30) Foreign Application Priority Data
Aug. 3, 2021 (GB) 2103166.1

(51) Int. Cl. B64G 1/40; B64G 1/24; F03H 3/00; G02F 1/365

(52) U.S. Cl. CPC B64G 1/409; B64G 1/244; F03H 3/00; G02F 1/365

(57) ABSTRACT

The disclosure describes a vehicle propulsion system that uses antimatter stored in a chamber stabilized by magnetic and/or electrostatic fields. The antimatter chamber is positioned at a distance from the vehicle's center of gravity to create a matter-antimatter dipole that generates propulsion. The system includes a propulsion apparatus with a laser that produces photons and an optical device that spatially separates some of the photons into electrons and positrons using nonlinear optical effects. These particles are coupled into separate optical fiber coils that preserve photon coherence as they propagate. The coils are arranged to be spaced apart or partially overlapping so that the separated electrons and positrons form a matter-antimatter dipole, which produces a propulsion force that drives the vehicle.

### CROSS REFERENCES TO RELATED APPLICATIONS

This Non-Provisional Patent Application is a Continuation-In-Part (CIP) application that claims the benefit of and priority to U.S. patent application Ser. No. 18/549,627, filed Sep. 8, 2023, entitled “Vehicle and Method for Propelling Vehicle,” which claims the benefit of and priority to PCT Application No. PCT/IB2022/052045, filed Aug. 3, 2022, entitled “Vehicle and Method for Propelling Vehicle,” which claims the benefit of and priority to United Kingdom Patent Application Serial No. GB 2103166.1, filed Aug. 3, 2021, entitled “Vehicle and Method for Propelling Vehicle,” the entire contents of each application of which are hereby incorporated herein by reference.

### TECHNICAL FIELD

The present disclosure relates to apparatus for generating propulsion forces by using matter-antimatter dipoles, for example to apparatus for generating propulsion forces by using matter-antimatter dipoles including a configuration of electrons and positrons for propelling a vehicle. Moreover, the present disclosure relates to methods for (namely, to methods of) generating propulsion forces by using matter-antimatter dipoles, for example by using aforesaid apparatus. Moreover, the present disclosure relates to energy converters, for example for use with the aforesaid apparatus. Additionally, the present disclosure relates to methods for (namely methods of) using the energy converters to provide output signals.

### BACKGROUND

Space exploration and associated space technology are one of the greatest achievements of modern science. Space exploration and space travel have helped achieve scientific breakthroughs in fields of healthcare, communication, weather forecasting, and the like. Despite significant achievements and advancements in technology relating to space travel and exploration, there exists significant challenges that limit capabilities of the human race to explore effectively and utilise the full potential of outer space, for example to utilise outer space existing at great distances from the earth.

In order to travel great distances from the Earth into outer space, for example to other planets than the earth, to other solar systems or even eventually to other galaxies, more advanced space vehicles and propulsion mechanisms need to be developed that can provide propulsion for extended periods of time for travelling aforesaid great distances. Furthermore, in order to travel such great distances, it is highly desirable to achieve space vehicle velocities that are substantially greater than velocities that contemporary space vehicles are capable of achieving. A primary challenge that limits human ability to perform space exploration is a requirement of a space vehicle to have a physical propellant or have some type of reaction mass to be ejected from the space vehicle to provide propulsion to the space vehicle (name, space craft). As the space vehicle is limited by an amount of weight that it may be able to carry into outer space, the amount of physical propellant or reaction mass that can be carried in the space vehicle is also limited, thereby limiting the distances the space vehicle is able to travel.

In conventional Newtonian physics, a mass of a given body is a positive parameter, wherein bodies with positive masses are mutually attracted to each other. Such forces cause planets in the solar system to revolve in elliptical orbits around the Sun and spiral galaxies to revolve around black holes at the centres of such galaxies. However, there exists antimatter in the universe that was generated at the Big Bang. Such antimatter has a negative mass, wherein a body of positive mass (i.e., matter) and a body with negative mass (i.e., antimatter) repel each other. Furthermore, momentum and kinetic energy of a moving antimatter body are also negative parameters. Notably, as matter and antimatter have opposing properties, when matter and antimatter collide, annihilation occurs releasing a large amount of energy. For example, a photon has components therein of matter and anti-matter.

Recent studies and experiments by physicists have suggested use of antimatter for providing propulsion to space vehicles. One such technique that has been suggested concerns utilising hypothetical collision sails for providing propulsion to space vehicles. Such a technique assumes the medium of space as a form of isotropic medium which is constantly impinging on all sides of a given space vehicle. Therefore, it is hypothesised that if matter-antimatter collisions on the front of a space craft could be lessened and/or the collisions on the back enhanced, a net propulsive force would result. As observed from various studies and experiments, small quantities of antimatter can be generated by using high-energy colliders, using particles accelerated to huge energies, for example in an order of MeV (Mega electron Volts) or even GeV. Therefore, antimatter is a limited resource and such techniques use antimatter as a propellant that can eventually be exhausted, thereby again limiting the distances of space travel.

The U.S. Patent Application Ser. No. 2002/0085661 titled “PROPULSION SYSTEM FOR SPACE VEHICLE” describes a propulsion system for a space vehicle designed as a fully self-contained system which does not eject particles to implement propulsion. The patent application provides that propulsion forces are generated by changing a mass of rings of charged particles by accelerating the rings of charged particles to velocities near the speed of light and back to a rest or near rest speed in an oscillatory manner. The propulsion system comprises closed tubes such as cyclotrons, wherein the rings are located within the tubes and are composed of charged particles in a form of electrons, positrons, protons, or plasmas. Electrostatic and magnetic fields are produced in the manner utilized with cyclotrons to rotate the rings of charged particles about a central axis of each of the tubes. The particles initially rotate slowly (and they are rotated in opposite directions, for example, the upper ring rotating clockwise and the lower ring rotating counterclockwise). The rotational velocity of the particles of the engine operating cycle is slow; moreover, the comparative mass of the particles is low. The rings of particles then are moved upward to a position near the top of the respective circular tubes comprising the engines. The rotational velocity of the particles then is increased while they are in this position until the particles achieve a very high relative rotational velocity. Once the high rotational velocity has been achieved, increasing the mass of the particles significantly by rotating the rings of particles to a near light speed, in opposite directions of rotation has been achieved, electromagnetic forces are used to move the particles downwardly in the engine compartments. This imparts an upward thrust on the overall vehicle. Moreover, such a propulsion arrangement is complex and bulky to implement.

Therefore, in light of the foregoing discussion, there exists a need to overcome the aforementioned drawbacks associated with conventional space crafts.

In a published PCT application WO2022/189964, “Vehicle and method for propelling vehicle”, inventor Ian Clague, there is described a method for generating a propulsion force by using one or more matter-antimatter dipoles, for propelling a vehicle, for example a space satellite. Although the nature of antimatter has been studied in recent years, for example in the ALPHA project being implemented by CERN, recently published research papers report that antimatter may be understood to have a negative mass and to break the symmetry of Newton's Third Law of Motion. Such an understanding leads to a given photon being considered to be a composite particle comprising an electron and a positron that, in aggregate, have zero mass and are thus able to propagate at “the speed c of light”, namely 299,792,458 metres per second, in vacuum; reference is herewith made to a published research paper “Examination of the Electromagnetic Force and Gravity through the Composite (Couplet) Photon”, Ian Clague, Advanced Studies in Theoretical Physics Vol. 16 year 2022 no. 2, pp. 41-86, wherein this research paper has been peer reviewed by several leading photonics academics and found to be in conformity with known laws of physics.

An energy of the given photon (namely E=hf wherein h is Plank's constant, E is the energy of the given photon and f is the frequency of the photon) is determined by parameters of a precession orbit of the electron in relation to its corresponding positron in the given photon; for example, lower energy infra-red photons have a larger precession orbit and therefore a longer corresponding wavelength than, example, a gamma ray photon. Such orbits are, for example, manifest in interference fringes generated using photons, for example in optical diffraction gratings. These aforesaid recently published research papers surpass earlier publications in which antimatter was incorrectly assumed to have a positive mass.

In modern physics, there occur “ordinary matter” (namely, positive matter) and corresponding antimatter (namely, negative matter). Antimatter may be conventionally thought of as being matter with reversed charge, parity and time, known as CPT reversal. Antimatter occurs in natural processes, for example in cosmic ray collisions occurring in the Earth's upper atmosphere and also as a component generated during radioactive decay, for example from radioactive decay giving rise to beta (β) particles being emitted. On Earth, antimatter tends to annihilate with ordinary matter to generate corresponding electromagnetic radiation, for example photons. However, it is known to store antimatter under vacuum conditions in at least one of strong electrostatic fields and magnetic fields for periods of up to circa 1000 hours. For example, the ALPHA project at CERN is concerned with generating positrons for research purposes, wherein the ALPHA project makes use of a high-energy particle accelerator to generate high-energy ordinary matter particles at an energy of GeV that are applied to a high-atomic-weight (“high-Z”) target to generate a range of secondary particles, wherein a portion of the secondary particles are positrons at high energy; a decelerator is then used to decelerate the high energy positrons to provide corresponding lower-energy positrons, and a vacuum storage ring arrangement is then used to store the lower-energy positrons for use in various experiments and research, for example for implementing anti-gravity research.

Referring to FIG. 15, there is shown a pair of “ordinary matter” masses indicated generally by 1010, wherein the pair of masses 1010 includes a first ordinary matter mass M₁ and a second ordinary matter mass M₂ separated by a distance R. In an absence of other external gravitational forces acting on the masses M₁, M₂, the masses M₁, M₂ mutually attract with forces F₁, F₂ mutually directed towards each other. The forces F₁, F₂ each have a magnitude as given by Equation 1 (Eq. 1), pursuant to classical Newtonian mechanics:

$${F}_{1} , {F}_{2} = \frac{G {M}_{1} {M}_{2}}{{R}^{2}} \qquad Eq . 1$$

wherein G is a universal gravitational constant. The forces F₁, F₂ are equal and directionally mutually opposite such that the masses M₁, M₂ in aggregate provide a net zero force.

In an event that the mass M₁ is antimatter, the mass M₁ has a negative sign in Equation 1, wherein the force F₁ is directed away from the mass M₂, such that the mass M₂ appears to “chase” the mass M₁, and the mass M₁ seeks to “escape” from the mass M₂. The masses M₁, M₂ in such a situation become an antimatter-matter dipole indicated generally by 1020 in FIG. 15, which is not normally encountered on Earth, because the antimatter mass M₁ would normally annihilate with air molecules to generate annihilation energy, unless the mass M₁ were held within a vacuum vessel. Creating vacuum conditions on the Earth's surface for storing antimatter often requires bulky ancillary equipment to be used such as a vacuum chamber and vacuum pumps, for example as aforementioned.

Conventionally, antimatter is very difficult and costly to generate on Earth. Positrons are an example of an antimatter particle that are generated by directing high-energy GeV particles beams at high atomic number, namely “high-Z”, targets as aforementioned, wherein a myriad of secondary particles are thereby generated of which a portion are positrons. Alternatively, positrons are generated when certain radioactive isotopes decay by giving rise to beta-particles (namely β-particles). Such beta-particles are effectively high-energy electrons; thus, radioactive beta-particle-emitting sources are used as positron generators in contemporary positron tomography apparatus. In view of aforesaid, antimatter has so far only been used in research studies and in specialist scientific equipment. However, astronomers are aware of examples of large quantities of antimatter present in the Universe, by inference of galaxy formations and from gravitational characteristics of black holes.

Vacuum apparatus for storing antimatter is conventionally relatively large and heavy, namely rather unsuitable for incorporating into, for example, a missile or satellite. Such a practical limitation potentially hitherto limits the use of matter-antimatter propulsion.

### SUMMARY

The present disclosure seeks to provide an improved apparatus for generating a propulsion force for propelling a vehicle. Moreover, the present disclosure seeks to provide a corresponding improved practical method for generating a propulsion force for propelling a vehicle, for example for propelling a space vehicle, a missile, a terrestrial vehicle and so forth.

According to a first aspect, there is provided vehicle including an apparatus for generating a propulsion force using a matter-antimatter dipole, as defined in the appended claim 1. A matter-antimatter dipole is defined as a portion of matter and a portion of antimatter disposed in a mutually spaced-apart spatial configuration. The apparatus is of advantage in that the apparatus is susceptible to being implemented in a compact form, for example for incorporation into a satellite, a rocket, a missile or similar.

According to a second aspect, there is provided a method for (namely, a method of) operating an apparatus for generating a propulsion force using a matter-antimatter dipole, as defined in the appended claim 16. The method is of advantage in that the method is susceptible to being implemented using an apparatus that has a compact form, for example suitable for incorporation into propulsion systems as used in a satellite, a rocket, a missile or similar.

According to a third aspect, there is provided a software product stored on a machine-readable data carrier, wherein the software product is executable on computing hardware for implementing the method of the second aspect.

Beneficially, one or more non-linear optical effects are used in the apparatus and in the method; the one or more non-linear optical effects include an optical Kerr effect. The optical Kerr effect results in a refractive index change that causes substrate electrons to group with other electrons, and likewise substrate positrons to group with other positrons, resulting in an enhanced positron-electron dipole, and thereby enhanced acceleration experienced by the electrons and the positrons within the apparatus. Such a phenomenon of grouping is known and has been practically demonstrated in a published research paper Wimmer et al.

In the Wimmer et al. published research paper, there is described an optical system wherein photons are separated into a region of effective antimatter and a region of effective matter in respective optical fibre waveguides by controlling group velocities of photons within the optical system, wherein the optical system exhibits in use an optical dispersion characteristic including two optical dispersion states, wherein one of the optical dispersion states favours matter (electrons) and another of the optical dispersion states favours antimatter (positrons).

Embodiments of the present invention are susceptible to being used, for example alone or in combination with other propulsion systems, to enable a cost reduction in apparatus required for propelling payloads in Earth's atmosphere (for example, into geostationary orbit) or into space remote from the Earth. The payloads may be, for example satellites, interplanetary research probes and similar. It will be appreciated contemporarily that only 5% of a launch rocket is its payload, whereas 95% of a launch rocket includes items such as propellant fuel, rocket engines and associated support equipment. In certain configurations, embodiments of the present disclosure may help to ease requirements for achieving a speed of circa 3 kilometres/second to achieve a geostationary orbit as is conventionally required for satellites.

According to a fourth aspect, there is provided an energy converter for converting electron-positron dipoles into an electrical output signal, for example for use in providing at least one of control signals and power to the aforesaid apparatus.

According to a fifth aspect, there is provided a method of using the energy converter of the fourth aspect for converting electron-positron dipoles into an electrical output signal, for example for use in providing at least one of control signals and power to the aforesaid apparatus.

The present disclosure seeks to provide a vehicle comprising an improved propulsion arrangement. The present disclosure also seeks to provide an improved method for propelling a vehicle comprising a propulsion arrangement. The propulsion arrangement comprises a dipole inertial drive, wherein two poles of matter and antimatter create a gravitational potential gradient around the vehicle which causes it to accelerate. An aim of the present disclosure is to provide a solution that overcomes at least partially the aforesaid problems encountered in prior art.

In a sixth aspect, the present disclosure provides a vehicle comprising a propulsion arrangement, wherein the propulsion arrangement includes a chamber arrangement that is configured to store antimatter (for example positrons) therein by using magnetic and/or electrostatic fields, wherein the chamber arrangement and a centre of gravity of the vehicle are positioned at a relative distance from each other to form a matter-antimatter dipole when in operation, and wherein the matter-antimatter dipole provides a propulsion force to the vehicle. The invention is of advantage in that when the amount of antimatter present is sufficient, a repulsive force can be generated that can levitate and propel the vehicle.

In a seventh aspect, an embodiment of the present disclosure provides a method for propelling a vehicle comprising a propulsion arrangement, wherein the method includes:
(i) arranging for the propulsion arrangement to include a chamber arrangement;
(ii) configuring the chamber arrangement to store antimatter (for example, positrons) therein by using magnetic and/or electrostatic fields; and
(iii) arranging for the chamber arrangement and a centre of gravity of the vehicle to be positioned at a relative distance from each other to form a matter-antimatter dipole when in operation, wherein the matter-antimatter dipole provides a propulsion force to the vehicle.

Embodiments of the present disclosure substantially eliminate, or at least partially address, the aforementioned problems in the prior art, and enable a vehicle that causes its own propulsion and adjustment of direction of travel without ejection of reaction mass to be realized.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

Embodiments of the invention will be described with reference to the following drawings, wherein:

FIG. 1 is a block diagram of a vehicle, in accordance with an embodiment of the present disclosure;

FIGS. 2 and 3 are schematic illustrations of a vehicle (for example a space vehicle or a vehicle to be used in Earth's atmosphere), in accordance with an embodiment of the present disclosure;

FIG. 4 is a schematic illustration of a tokamak ring-shaped chamber, in accordance with an embodiment of the present disclosure;

FIG. 5 is a schematic illustration of a propulsion arrangement, in accordance with an embodiment of the present disclosure;

FIG. 6 is a schematic illustration of a buffer-gas trap, in accordance with an embodiment of the present disclosure;

FIG. 7 is a flowchart depicting steps of a method for propelling a vehicle, in accordance with an embodiment of the present disclosure; and

FIGS. 8A, 8B, 9, 10, 11, 12, 13 and 14 are schematic illustrations of underlying technical concepts that are relevant to understanding embodiments of the present disclosure;

FIG. 15 is a schematic illustration of mutual gravitation forces acting on masses of various types;

FIG. 16 is a schematic illustration of component parts of an apparatus of the present disclosure for generating a propulsion force by using a matter-antimatter dipole, for example for propelling a vehicle such as a missile or satellite;

FIG. 17 is a schematic cross-sectional view of a monomode optical fibre for use in the apparatus of FIG. 16;

FIG. 18 is a schematic illustration a pair of waveguides of a waveguide arrangement of the apparatus of FIG. 16, wherein the waveguides are separated by a distance “x”, have a thickness height “h” above a substrate, wherein each waveguide has a width “w”;

FIG. 19A is an illustration of a waveguide arrangement for use in the apparatus of FIG. 16, wherein the waveguide arrangement is configured to use non-linear optical effects, for example the Kerr effect, to separate photons into corresponding regions enriched with positrons and electrons, while maintaining coherence, to generate a matter-antimatter dipole for generating a propulsion force; the waveguide arrangement may be beneficially configured to function as an energy converter for converting the matter-antimatter dipole into an electrical output signal;

FIG. 19B is an illustration of a waveguide arrangement for use in the apparatus of FIG. 16, wherein the waveguide arrangement is configured to use non-linear optical effects, for example the Kerr effect, to separate photons into corresponding regions enriched with positrons and electrons, while maintaining coherence, to generate a matter-antimatter dipole for generating a propulsion force; the waveguide arrangement may be beneficially configured to function as an energy converter for converting the matter-antimatter dipole into an electrical output signal; the waveguide arrangement of FIG. 19B has its capacitively-coupled electrodes for harvesting electrons and positrons configured along only distal ends of their corresponding optical waveguides of the waveguide arrangement;

FIG. 20 is a schematic illustration of a use application for the apparatus of FIG. 16 for a vehicle in space, wherein the apparatus is configured to provide forces selectively in respect of Cartesian axes and rotational axes; and

FIG. 21 is a flow chart depicting steps of a method for generating a propulsion force from photons by using the apparatus of FIG. 16.

In the accompanying drawings, an underlined number is used to represent an item over which the underlined is positioned or an item to which the underlined number is adjacent. A non-underlined number relates to an item identified by a line linking the non-underlined number to the item. When a number is non-underlined and accompanies by an associated arrow, the non-underlined number is used to identify a general item at which the arrow is pointing.

### DETAILED DESCRIPTION

According to a first aspect, there is provided an apparatus for generating a propulsion force, wherein the apparatus includes:
a laser arrangement for generating photons;
an optical device including an optical region for spatially separating at least a portion of the photons into corresponding electrons and positrons;
a coupling arrangement for coupling the positrons and electrons into respective corresponding coils of optical fibre;
   wherein the optical device and the coils preserve a coherence of the photons as they propagate in use around the coils (namely, “preserve a coherence of wavefunctions of the photons as they propagate in use around the coils”);
   wherein the coils are disposed to be spatially mutually space apart or only partially spatially overlapping, for the electrons and positrons to generate a matter-antimatter dipole for generating the propulsion force; and
   wherein the optical region of the optical device is configured to exhibit in use a non-linear optical effect for spatially separating the at least a portion of the photons into the corresponding electrons and positrons.

Optionally, in the apparatus, the non-linear optical effect includes an optical Kerr effect that causes spatial separation of the photons into their corresponding electrons and positrons. Such separation is known from earlier published research papers and conforms to known physical laws.

In the Wimmer et al. published research paper, there is described an optical system wherein photons are separated into a region of effective antimatter and a region of effective matter in respective optical fibre waveguides by controlling group velocities of photons within the optical system, wherein the optical system exhibits in use an optical dispersion characteristic including two optical dispersion states, wherein one of the optical dispersion states favours matter (electrons) and another of the optical dispersion states favours antimatter (positrons).

Optionally, in the apparatus, the coils include first and second coils, wherein the optical fibre of the first coil is mutually different in length to the optical fibre of the second coil.

Optionally, the apparatus is configured to function as an optical system having optical dispersion characteristics include at least two optical dispersion states, wherein one of the dispersion states is arranged to have an enhanced electron occupation, and wherein another of the dispersion states is arranged to have an enhanced positron occupation, thereby enabling the coils to form a matter-antimatter dipole. Such dispersion states are described in detail in a published research paper “Optical diametric drive acceleration through action-reaction symmetry breaking” Wimmer et al., Nature Physics, October 2013, DOI: 101038/NPHYS2777.

Optionally, in the apparatus, the optical region includes one or more optical materials for use in generating the non-linear optical effect, wherein the one or more optical materials optionally include at least one of: Lithium Niobate, Copper-doped bulk Lithium Niobate, Lithium-Niobate-On-Insulator (LNOI, TFLN), Barium Titanate, Barium Niobate, Graphene, doped Graphene, n-doped optically-transmissive material, p-doped optically-transmissive material.

Optionally, in the apparatus, the optical region includes one or more optical materials for use in generating the non-linear optical effect, wherein the one or more optical materials include a zero band-gap material. More optionally, in the apparatus, the one or more optical materials include one or more superconducting polymers for use in waveguides of the operating region, wherein the one or more superconducting polymers optionally include bis(ethylenedithio)-tetrathiafulvalen.

Optionally, in the apparatus, the optical region is supported by at least one substrate that includes a dielectric material. More optionally, in the apparatus, the dielectric material of the at least one substrate includes at least one of: Silicon, silica, quartz, sapphire, Silicon Dioxide, Silicon Nitride. More optionally, in the apparatus, the at least one substrate includes a dielectric layer formed onto a bulk Silicon substrate, wherein the operating region is fabricated onto the dielectric layer, remote from the Silicon substrate; optionally, the dielectric layer includes Silicon Dioxide.

Optionally, in the apparatus, the optical region includes at least two waveguides, for example in a range of two to five hundred waveguides, that are mutually spatially disposed on the at least one substrate to support spatial segregation of the one or more electrons and the one or more positrons to generate the one or more corresponding matter-antimatter dipoles, and to maintain coherence of the one or more photons giving rise the one or more matter-antimatter dipoles as they propagate within the optical region and the coils. The at least two waveguides are beneficially configured to exhibit, when in use, optical dispersion characteristics including at least two optical dispersion states, wherein one of the dispersion states is arranged to have an enhanced electron occupation, and wherein another of the dispersion states is arranged to have an enhanced positron occupation, thereby enabling a matter-antimatter dipole to be formed. Such dispersion states are described in detail in the aforesaid published research paper “Optical diametric drive acceleration through action-reaction symmetry breaking” Wimmer et al., Nature Physics, October 2013, DOI: 101038/NPHYS2777.

Optionally, in the apparatus, the optical device is configured to selectively propagate photons of Bloch modes, more optionally Floquet-Bloch modes.

Optionally, the apparatus further includes an energy collection arrangement for extracting energy, wherein the energy collection arrangement includes one or more electrodes configured to have their elongate axes substantially parallel or in a curved formation in the optical region to collect electrons therefrom arising from the one or more antimatter-matter dipoles formed therein, wherein the one or more electrodes are configured to be included, at least in part, substantially within a spatial extent of wavefunctions of photons propagating in the optical region. When the laser arrangement is beneficially operated in a pulsed mode, electron and positron charge concentrations arise momentarily in the at least two waveguides that are Coulombically capacitively coupled to the one or more electrodes, giving rise to an output signal. More optionally, the apparatus is configured to provide at least a portion of the extracted energy, for example from the one or more electrodes, to the laser arrangement.

Optionally, the apparatus is configured to operate the laser arrangement in a pulsed mode to generate the photons in pulses.

According to a second aspect, there is provided a method for (namely, a method of) operating an apparatus for generating a propulsion force, wherein the method includes:
configuring a laser arrangement of the apparatus to generate photons;
configuring an optical device of the apparatus to include an optical region to spatially separate at least a portion of the photons into corresponding electrons and positrons;
configuring a coupling arrangement of the apparatus to couple the at least a portion of positrons and electrons into respective corresponding coils of optical fibre;
   wherein the method further includes:
configuring the optical device and the coils to preserve a coherence of the photons as they propagate in use around the coils (namely, “preserve a coherence of wavefunctions of the photons as they propagate in use around the coils”);
configuring the coils to be disposed to be spatially mutually space apart or only partially spatially overlapping, for the electrons and positrons to generate a matter-antimatter dipole for generating the propulsion force; and
configuring the optical region of the optical device to exhibit in use a non-linear optical effect for spatially separating the at least a portion of the photons into the corresponding electrons and positrons.

Optionally, in the method, the apparatus is configured to function as an optical system having optical dispersion characteristics include at least two optical dispersion states, wherein one of the dispersion states is arranged to have an enhanced electron occupation, and wherein another of the dispersion states is arranged to have an enhanced positron occupation, thereby enabling the coils to form a matter-antimatter dipole. Such dispersion states are described in detail in the aforesaid published research paper “Optical diametric drive acceleration through action-reaction symmetry breaking” Wimmer et al., Nature Physics, October 2013, DOI: 101038/NPHYS2777.

Optionally, in the method, the non-linear optical effect includes an optical Kerr effect that causes spatial separation of the photons into their corresponding electrons and positrons.

Optionally, in the method, the optical region includes one or more optical materials for use in generating the non-linear optical effect, wherein the one or more optical materials include at least one of: Lithium Niobate, Lithium Niobate On Insulator (LNOI0, TFLN), Barium Titanate, Barium Niobate, Graphene, doped Graphene, n-doped optically-transmissive material, p-doped optically-transmissive material.

Optionally, in the method, the optical region includes one or more optical materials for use in generating the non-linear optical effect, wherein the one or more optical materials include a zero band-gap material. More optionally, in the method, the one or more optical materials include one or more superconducting polymers for use in waveguides of the operating region, wherein the one or more superconducting polymers include bis(ethylenedithio)-tetrathiafulvalen.

Optionally, in the method, the optical region is supported by at least one substrate that includes a dielectric material. More optionally, in the method, the dielectric material of the at least one substrate includes at least one of: silica, quartz, sapphire, Silicon. More optionally, in the method, the at least one substrate includes a dielectric layer formed onto a bulk Silicon substrate, wherein the operating region is fabricated onto the dielectric layer, remote from the Silicon substrate; the dielectric layer includes, for example, at least one of Silicon Dioxide, Silicon Nitride.

Optionally, the method includes configuring the optical region to include at least two waveguides that are mutually spatially disposed on the at least one substrate to support spatial segregation of the one or more electrons and the one or more positrons to generate the one or more corresponding matter-antimatter dipoles, and to maintain coherence of the one or more photons giving rise the one or more matter-antimatter dipoles as they propagate within the operating region and the coils.

Optionally, the method further includes configuring the optical device to selectively propagate photons of Bloch modes, more optionally Floquet-Bloch modes.

Optionally, the method includes configuring the apparatus to further include an energy collection arrangement for extracting energy, wherein the energy collection arrangement includes one or more electrodes configured to have their elongate axes substantially parallel or in a curved formation in the optical region to collect electrons therefrom arising from the one or more antimatter-matter dipoles to generate an output signal, wherein the one or more electrodes are configured to be included within a spatial extent of wavefunctions of photons propagating in the optical region. The one or more electrodes are beneficially Coulombically capacitively coupled to the one or more electrodes to generate the output signal.

Optionally, the method includes configuring the apparatus to provide at least a portion of the extracted energy to the laser arrangement, for example provided from the output signal generated at the one or more electrodes.

Optionally, the method includes configuring the apparatus to operate the laser arrangement in a pulsed mode to generate the photons in pulses.

According to a third aspect, there is provided a software product stored on a machine-readable data carrier, wherein the software product is executable on computing hardware for implementing a method of the second aspect

According to a fourth aspect, there is provided an energy converter for generating an output signal, wherein the energy converter includes:
a laser arrangement for generating photons;
an optical device including an optical region for spatially separating at least a portion of the photons into corresponding electrons and positrons, to generate matter-antimatter dipoles in the optical region;
an energy collection arrangement for coupling to the matter-antimatter dipoles to generate the output signal,
   wherein the optical region of the optical device is configured to exhibit in use a non-linear optical effect for spatially separating the at least a portion of the photons into the corresponding electrons and positrons.

Beneficially, the energy converter is included in the apparatus of the first aspect for providing the output signal thereto, for example to assist to energize the laser arrangement or to control the laser arrangement. However, it will be appreciated that the energy converter may optionally be used for other apparatus that are unrelated to the apparatus of the first aspect.

Optionally, in the energy converter, the non-linear optical effect includes an optical Kerr effect that causes spatial separation of the photons into their corresponding electrons and positrons.

Optionally, the energy converter is configured to function as an optical system having optical dispersion characteristics include at least two optical dispersion states, wherein one of the dispersion states is arranged to have an enhanced electron occupation, and wherein another of the dispersion states is arranged to have an enhanced positron occupation, thereby enabling to form a matter-antimatter dipole. Such dispersion states are described in detail in a published research paper “Optical diametric drive acceleration through action-reaction symmetry breaking” Wimmer et al., Nature Physics, October 2013, DOI: 101038/NPHYS2777.

Optionally, in the energy converter, the optical region includes one or more optical materials for use in generating the non-linear optical effect, wherein the one or more optical materials optionally include at least one of: Lithium Niobate, Copper-doped bulk Lithium Niobate, Lithium-Niobate-On-Insulator (LNOI, TFLN), Barium Titanate, Barium Niobate, Graphene, doped Graphene, n-doped optically-transmissive material, p-doped optically-transmissive material.

Optionally, in the energy converter, the optical region includes one or more optical materials for use in generating the non-linear optical effect, wherein the one or more optical materials include a zero band-gap material. More optionally, in the apparatus, the one or more optical materials include one or more superconducting polymers for use in waveguides of the operating region, wherein the one or more superconducting polymers optionally include bis(ethylenedithio)-tetrathiafulvalen.

Optionally, in the energy converter, the optical region is supported by at least one substrate that includes a dielectric material. More optionally, in the apparatus, the dielectric material of the at least one substrate includes at least one of: Silicon, silica, quartz, sapphire, Silicon Dioxide, Silicon Nitride. More optionally, in the apparatus, the at least one substrate includes a dielectric layer formed onto a bulk Silicon substrate, wherein the operating region is fabricated onto the dielectric layer, remote from the Silicon substrate; optionally, the dielectric layer includes Silicon Dioxide.

Optionally, in the energy converter, the optical region includes at least two waveguides, for example in a range of two to five hundred waveguides, that are mutually spatially disposed on the at least one substrate to support spatial segregation of the one or more electrons and the one or more positrons to generate the one or more corresponding matter-antimatter dipoles, and to maintain coherence of the one or more photons giving rise the one or more matter-antimatter dipoles as they propagate within the optical region and the coils. The at least two waveguides are beneficially configured to exhibit, when in use, optical dispersion characteristics including at least two optical dispersion states, wherein one of the dispersion states is arranged to have an enhanced electron occupation, and wherein another of the dispersion states is arranged to have an enhanced positron occupation, thereby enabling a matter-antimatter dipole to be formed. Such dispersion states are described in detail in the aforesaid published research paper “Optical diametric drive acceleration through action-reaction symmetry breaking” Wimmer et al., Nature Physics, October 2013, DOI: 101038/NPHYS2777.

Optionally, in the energy converter, the optical device is configured to selectively propagate photons of Bloch modes, more optionally Floquet-Bloch modes.

Optionally, the energy converter further includes an energy collection arrangement for extracting energy, wherein the energy collection arrangement includes one or more electrodes configured to have their elongate axes substantially parallel or in a curved formation in the optical region to collect electrons therefrom arising from the one or more antimatter-matter dipoles formed therein, wherein the one or more electrodes are configured to be included, at least in part, substantially within a spatial extent of wavefunctions of photons propagating in the optical region. When the laser arrangement is beneficially operated in a pulsed mode, electron and positron charge concentrations arise momentarily in the at least two waveguides that are Coulombically capacitively coupled to the one or more electrodes, thereby giving rise to the output signal. More optionally, the energy converter is configured to provide at least a portion of the extracted energy, for example from the one or more electrodes, to the laser arrangement.

Optionally, the energy converter is configured to operate the laser arrangement in a pulsed mode to generate the photons in pulses.

According to a fifth aspect, there is provided a method of using an energy converter for generating an output signal, wherein the method includes:
using a laser arrangement of the energy converter for generating photons;
using an optical device of the energy converter, wherein the optical device includes an optical region, for spatially separating at least a portion of the photons into corresponding electrons and positrons, to generate matter-antimatter dipoles in the optical region;
using an energy collection arrangement of the energy converter for coupling to the matter-antimatter dipoles to generate the output signal,
   wherein the optical region of the optical device is configured to exhibit in use a non-linear optical effect for spatially separating the at least a portion of the photons into the corresponding electrons and positrons.

The following detailed description illustrates embodiments of the present disclosure and ways in which they can be implemented. Although some modes of carrying out the present disclosure have been disclosed, those skilled in the art will recognize that other embodiments for carrying out or practising the present disclosure are also possible.

In one aspect, the present disclosure provides a vehicle comprising a propulsion arrangement, wherein the propulsion arrangement includes a chamber arrangement that is configured to store antimatter (for example, positrons) therein by using magnetic and/or electrostatic fields, wherein the chamber arrangement and a centre of gravity of the vehicle are positioned at a relative distance from each other to form a matter-antimatter dipole when in operation, and wherein the matter-antimatter dipole provides a propulsion force to the vehicle.

In another aspect, in a more bulky implementation, an embodiment of the present disclosure provides a method for propelling a vehicle comprising a propulsion arrangement, wherein the method includes:
(i) arranging for the propulsion arrangement to include a chamber arrangement;
(ii) configuring the chamber arrangement to store antimatter (for example, positrons) therein by using magnetic and/or electrostatic fields; and
(iii) arranging for the chamber arrangement and a centre of gravity of the vehicle to be positioned at a relative distance from each other to form a matter-antimatter dipole when in operation, wherein the matter-antimatter dipole provides a propulsion force to the vehicle.

The present disclosure provides a vehicle including a propulsion arrangement, and a method of propelling the vehicle using the propulsion arrangement. The vehicle as described in the present disclosure causes its own propulsion by employing a matter-antimatter dipole without ejection of any reaction mass from the vehicle. The present disclosure further provides a compact and practical antimatter propulsion arrangement that can be used in vehicles, for example in space vehicles (namely, spacecrafts) or deep-space satellites. Furthermore, acceleration and direction of travel of the vehicle as described in the present disclosure can beneficially be controlled by adjusting position of the chamber arrangement and without use of any physical propellants. Notably, the vehicle described herein is suited for extended periods of travel.

Pursuant to embodiments of the present disclosure, there is provided a vehicle, and a method of propelling the vehicle using antimatter. Herein, the term “vehicle” refers to an apparatus that can be used for transporting people or cargo using a propulsion force. Notably, the propulsion force has to be of a higher magnitude to balance forces acting on the vehicle, such as the inertial force, to impart motion to the vehicle. Examples of the vehicle may include, but are not limited to, motor vehicles, railed vehicles, watercraft, aircraft. In an embodiment, the vehicle is a space vehicle (namely, spacecraft).

Notably, modern physics research has identified that a force of gravitational repulsion exists between matter and antimatter. It is this force that is being harnessed in the dipole matter-antimatter drive to provide propulsion for the aforesaid vehicle. Moreover, the strength of this repulsive gravitational force has been found to be much stronger than Newtonian gravity. This means that a relatively small amount of antimatter provides a large force of propulsion to the body of the spacecraft, which consists of matter. Indeed, the repulsive gravitational force has been found to be 1045 (ten to the power 45) times more powerful than Newtonian gravity.

The vehicle comprises a propulsion arrangement. The propulsion arrangement includes a chamber arrangement that is configured to store antimatter therein, for example positrons therein, by using magnetic and/or electrostatic fields. Herein, the term “positron” refers to antimatter part of the electron having an electric charge of +le and a spin of ½. It will be appreciated that when antimatter is contacted by electrons or matter particles, annihilation occurs generating two photons. Therefore, positrons are to be generated in vacuum conditions and suspended in the chamber arrangement using magnetic and/or electrostatic fields in a manner that positrons are not contacted by any matter.

In an embodiment, the chamber arrangement is beneficially implemented as a tokamak ring-shaped chamber that is configured to store the antimatter along an annular central magnetic axis of the tokamak ring-shaped chamber. Notably, the tokamak ring-shaped chamber is shaped in the form of a ring or a torus, wherein toroidal field coils are helically wound around the torus to induce a magnetic field along the annular central magnetic axis thereof. Additionally, or alternatively, optionally, the tokamak ring-shaped chamber employs permanent neodymium magnets to suspend the positrons in the chamber arrangement. The tokamak ring-shaped chamber provides a high-vacuum, hermetically sealed chamber for the positrons, wherein the positrons continuously spiral around the annular central magnetic axis without touching the walls.

According to an embodiment, the propulsion arrangement further comprises a laser arrangement, a target that is configured to be stimulated by a laser beam generated by the laser arrangement to produce positrons, and a deflector arrangement that is configured to guide the positrons generated at the target into the chamber arrangement. Notably, the laser beam generated by the laser arrangement is directed towards the target, wherein the laser beam ionizes and accelerates electrons, which are driven through the target. Optionally, the laser beam may be a pulsed laser beam or a laser beam having a high intensity. Herein, as the electrons are driven through the target, the electrons interact with nuclei of the target, wherein the nuclei serve as a catalyst to create positrons. The electrons emit packets of energy, wherein the energy decays into matter and antimatter, following the predictions by Einstein's equation relating to matter and energy (E=mc²). Notably, by concentrating the energy in space and time, the laser beam produces positrons in a high density. The target may have a thickness in an order of a few millimetres and may be manufactured using Gold, Erbium or Tantalum, for example. As the positrons are generated, the deflector arrangement guides the positrons into the chamber arrangement. Optionally, the target is spatially integrated with the tokamak ring-shaped chamber.

In an embodiment, the target further comprises a composite Copper-Gold, Copper-Erbium or Copper-Tantalum structure that is irritated with pulsed laser beams, wherein the composites upon irradiation generate intense laser beams that subsequently excite the Gold, Erbium or Tantalum target to generate antimatter.

Optionally, the target is provided with one or more fluid channels for accommodating a flow of a cooling fluid therethrough for cooling the target. More optionally, the target may be a Gold sheet, an Erbium sheet or a Tantalum sheet that is bonded to a heat sink, wherein the heat sink includes internal fluid channels therein for accommodating a flow of a cooling fluid for cooling the heat sink and its Gold, Erbium or Tantalum sheet. It will be appreciated that when blasted with accelerated particles or laser beams, the target may reach a high temperature, unless cooled by using a cooling fluid as aforementioned. The one or more internal fluid channels for accommodating a flow of cooling fluid reduces an operating temperature of the target, thereby enabling a safe operation thereof.

Optionally, the target is raster scanned by a laser beam or high-energy particle beam over its entire area rather than being maintained on just one area of the target. Beneficially, such raster scanning ensures that thermal dissipation occurs over the entire area of the target, thereby avoiding localized sputtering, evaporation or ablation of the target. This can be achieved by scanning the beam or actuating the target, or a mixture of both. Optionally, the vehicle further comprises a control feedback loop wherein vehicle acceleration is served back to the particle to the laser arrangement exciting the target.

Optionally, the laser arrangement includes one or more Q-switched lasers that are configured to generate light pulses that cause the positrons to be generated in the target. Notably, the Q-switched laser produces light pulses of high peak power, specifically in an order of gigawatts. The light pulses produced by the one or more Q-switched lasers generally produce light pulses that last a few nanoseconds. Such short operational time allows greater control over the generation of positrons at the target. It will be appreciated that a Q-switched laser of high intensity may generate a high ratio of positrons to electrons, possibly approaching a neutral “pair plasma” with equal numbers of positrons and electrons.

According to another embodiment, the propulsion arrangement further comprises a particle accelerator arrangement, a target that is configured to be stimulated by a particle beam generated by the particle accelerator arrangement to produce positrons, and a deflector arrangement that is configured to guide the positrons generated at the target into the chamber arrangement. Notably, the particle accelerator arrangement uses electromagnetic fields to propel charged particles, such as protons or electrons, to very high speeds and energies, and to contain them in well-defined beams. Subsequently, the charged particles are either smashed onto a target or against other particles circulating in an opposite direction, thereby generating beams of electrons, positrons, protons, and antiprotons, interacting with each other or with the simplest nuclei at the highest possible energies, generally hundreds of GeV or more. As the positrons are generated, the deflector arrangement guides the positrons into the chamber arrangement. It will be appreciated that electrons are guided into the chamber arrangement in high-vacuum conditions, wherein the target, the deflection arrangement and the interior of the chamber arrangement needs to be evacuated of air when the propulsion arrangement is in operation.

Optionally, the deflector arrangement includes one or more electromagnetic and/or electrostatic lenses for focusing the positrons generated at the target as a positron beam to feed into the chamber arrangement. Notably, the deflector arrangement ensures that the positrons generated at the target do not contact any matter and are focused as a positron beam into the chamber arrangement to be suspended therein using magnetic and/or electrostatic fields. The electromagnetic lens used herein may be similar in its operation to electromagnetic lenses as used in a conventional scanning electron microscope (SEM). Furthermore, the deflector arrangement is maintained at a potential difference in comparison with the target to draw positrons away from the target and into the chamber arrangement. Additionally, optionally, the deflector arrangement may employ permanent neodymium magnets for focusing the positrons into the chamber arrangement.

In an embodiment, the chamber arrangement is implemented as a stellarator that is configured to store the antimatter therein. Notably, the stellarator is a device that employs external magnets to confine positrons therein.

In an embodiment, the chamber arrangement is implemented as a buffer-gas trap comprising a Penning-Malmberg type electromagnetic trap to store antimatter therein. It will be appreciated that magnetic fields required for operating the chamber arrangement need to be of considerable strength since the magnetic fields will effectively bear a weight of the vehicle. The buffer-gas trap, is a type of ion-trap that provides an axial electric charge which prevents the positively charged positrons from escaping radially. Specifically, antimatter is confined in a vacuum inside an electrode structure consisting of a stack of hollow, cylindrical metal electrodes. A uniform axial magnetic field inhibits positron motion radially, and voltages imposed on end electrodes prevent axial loss.

Optionally, the target, for example, a Gold, Erbium or Tantalum target is spatially integrated with the buffer-gas trap. Notably, the antimatter generated at the target are consequently transferred to the buffer-gas trap for storage. Beneficially, the buffer-gas trap is a compact and light-weight implementation of the chamber arrangement and can be used to propel vehicles such as geostationary satellites to maintain their orbital positions as a function of elapsed time. Furthermore, the buffer-gas trap slows down an antimatter beam to electron-volt energies and accumulates them in the trap. Pursuant to the embodiments describing the buffer-gas trap, the present disclosure employs a modified Penning-Malmberg trap as the buffer-gas trap that comprises of a series of cylindrically symmetric electrodes of varying inner diameters. These form three distinct trapping stages with three distinct pressure regions, and confine the antimatter axially by producing electrostatic potentials. The antimatter is confined radially by a static magnetic field produced by one solenoid enclosing the electrodes. The principle of this trap is that incoming positrons lose their energy through inelastic collisions with a buffer gas that is introduced in the first stage of the trap. As they cool down, they become trapped in successively deeper potential wells, and progressively lower pressure, until the positrons are confined on the lowest pressure region of the trap, where the lifetime is longer. It is to be noted that in order to trap antimatter with a few tens of electron-volt energy, they must lose enough energy so that they do not exit the trap once they are reflected by the end potential barrier. The cooling mechanism employed in this type of traps is the inelastic collisions a positron undergoes with the buffer gas.

The chamber arrangement and a centre of gravity of the vehicle are positioned at a relative spatial distance from each other to form a matter-antimatter dipole when in operation, and wherein the matter-antimatter dipole provides a propulsion force to the vehicle. Herein, the centre of gravity of the vehicle is a point at which a weight of the vehicle is evenly distributed around it. Notably, a repulsive gravitational force exists between the antimatter in the chamber and the body of the spacecraft which consists of matter. Moreover, this force of repulsive gravity is much stronger than Newtonian gravity. This strong force of repulsive gravity allows the vehicle to accelerate at rates of acceleration up to 5,000 g. Such a rate of acceleration allows the spacecraft to escape Earth's gravitational pull. It will be appreciated that similar arrangements with respect to the matter-antimatter dipole may be employed to overcome forces such as inertial force or frictional force of a road.

It will be appreciated that the present disclosure does not intend to limit the scope of the claims to positrons as the antimatter employed for formation of the matter-antimatter dipole. Notably, antimatter such as antiprotons or antihydrogen may be employed to form a similar matter-antimatter dipole for providing propulsion force to the vehicle.

Optionally, the chamber arrangement is configured to be angularly adjustable with respect to the centre of gravity of the vehicle for steering the vehicle. Specifically, an angular position of the chamber arrangement with respect to the centre of gravity of the vehicle changes a direction of the propulsion force provided by the matter-antimatter dipole. Consequently, a direction of movement of the vehicle can be adjusted accordingly. This allows the vehicle to accelerate in any spatial direction, including upwards and downwards.

Optionally, at least one of rocket thrusters or ion motors are used for steering the vehicle. Notably, rocket thrusters are propulsion devices that expel pressurised gas (such as in cold gas thrusters) or ionized air (such as in electrohydrodynamic thrusters) to control a direction of travel of the vehicle. Similarly, ion motors or ion thrusters create a thrust by accelerating ions using electricity to provide directional assistance to the vehicle.

Optionally, the propulsion force provided by the matter-antimatter dipole is increased by adding positrons to the chamber arrangement, and the acceleration is decreased by dissipating a given amount of the positrons stored in the chamber arrangement. Notably, adding positrons to the chamber arrangement increases the propulsion force provided by the matter-antimatter dipole to the vehicle, thereby providing acceleration to the vehicle. Similarly, the given amount of positrons are dissipated by contacting the positrons with electrons in a controlled manner, thereby reducing the positrons in the chamber arrangement by the given amount and reducing the acceleration provided by the matter-antimatter dipole. Furthermore, energy released from the dissipation of the positrons may be harnessed to support additional functions in the vehicle, such as temperature control, or may be used for deceleration of the vehicle if required.

Optionally, the propulsion force provided by the matter-antimatter dipole is increased by increasing the relative distance between the chamber arrangement and the centre of gravity of the vehicle and the propulsion force is decreased by decreasing the relative distance between the chamber arrangement and the centre of gravity of the vehicle. Such adjustment of the distance can be achieved by using one or more actuators.

Optionally, the propulsion arrangement is configured to provide the propulsion force in a direction that is opposite to a gravitational force of a planet in respect of which the vehicle is operating. Notably, the positrons in the chamber arrangement have a negative mass and therefore, experience a force in a direction that is opposite to the gravitational force of a planet with respect to which the vehicle is operating, for example earth. Therefore, such a force experienced by the positrons is employed to provide propulsion force from the matter-antimatter dipole to the vehicle.

Optionally, the vehicle further comprises a spin-stabilisation arrangement. Notably, the spin-stabilisation arrangement employs mass-expulsion control thrusters to continually nudge the vehicle back and forth within a deadband of allowed attitude error. Additionally, or alternatively, optionally, the spin-stabilisation arrangement comprises electrically powered reaction wheels, also called momentum wheels, that are mounted on three orthogonal axes aboard the vehicle. It will be appreciated that it is possible to create a continuously propulsive effect by the juxtaposition of negative and positive mass. The poles of negative mass and positive mass may be seen as negative and positive gravitational charges which create a potential gradient between them. The accelerations for positive mass and negative mass align in the same direction and a self-acceleration effect provides propulsion. Notably, antimatter has negative mass and there is a strong gravitational force acting between matter and antimatter.

Since,

This is the Gravitational Constant for strong gravity

$${G}_{s} = \frac{2 ℏ c}{{{m}_{e}}^{2}}$$

This compares to:

$$G = \frac{ℏ c}{{{M}_{p}}^{2}}$$

For Newton's Gravitational Constant, where Mp=Planck mass.

This strong gravitational force is stronger than the Newtonian gravitational force in the ratio:

$${G}_{s} / G = \frac{2 {{M}_{p}}^{2}}{{{m}_{e}}^{2}}$$

or 45 orders of magnitude stronger than the Newtonian me 2 gravitational force

For a spacecraft with the same weight as the space shuttle orbiter (110,000 kg), gravitational field produced by negative mass is:

$$\frac{{G}_{s} {m}_{-}}{{d}^{2}}$$

where m_ is the negative mass and d is the distance between the d₂ masses. Gravitational repulsive force felt by the spacecraft is:

$$F = \frac{{G}_{s} {m}_{-}^{2}}{{d}^{2}} = {M}_{+} a$$

$$a = \frac{{G}_{s} {m}_{-}^{2}}{{M}_{+} {d}^{2}}$$

where M+ is the positive mass of the spacecraft and a is the acceleration of the spacecraft. For example, 3.16×1016 positrons give an acceleration of 936 g for our spacecraft weighing 110,000 kg.

### DETAILED DESCRIPTION OF THE DRAWINGS

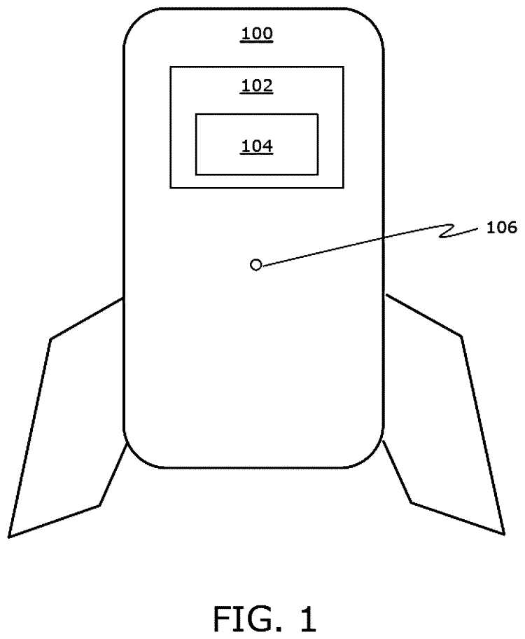

Referring to FIG. 1, there is shown a block diagram of a vehicle 100, in accordance with an embodiment of the present disclosure. The vehicle comprises a propulsion arrangement 102. The propulsion arrangement 102 includes a chamber arrangement 104 that is configured to store antimatter, for example positrons, therein by using magnetic and/or electrostatic fields. The chamber arrangement 104 and a centre of gravity 106 of the vehicle 100 are positioned at a relative distance from each other to form a matter-antimatter dipole when in operation. The matter-antimatter dipole provides a propulsion force to the vehicle 100.

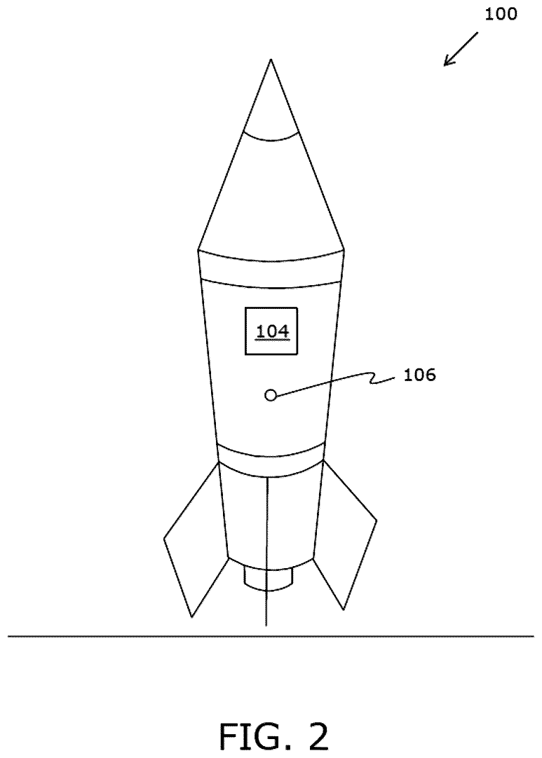

Referring to FIG. 2, there is shown a schematic illustration of the vehicle 100, in accordance with an embodiment of the present disclosure. Notably, the chamber arrangement 104 and a centre of gravity 106 of the vehicle 100 are positioned at a relative distance from each other to form a matter-antimatter dipole when in operation. The matter-antimatter dipole provides a propulsion force to the vehicle 100.

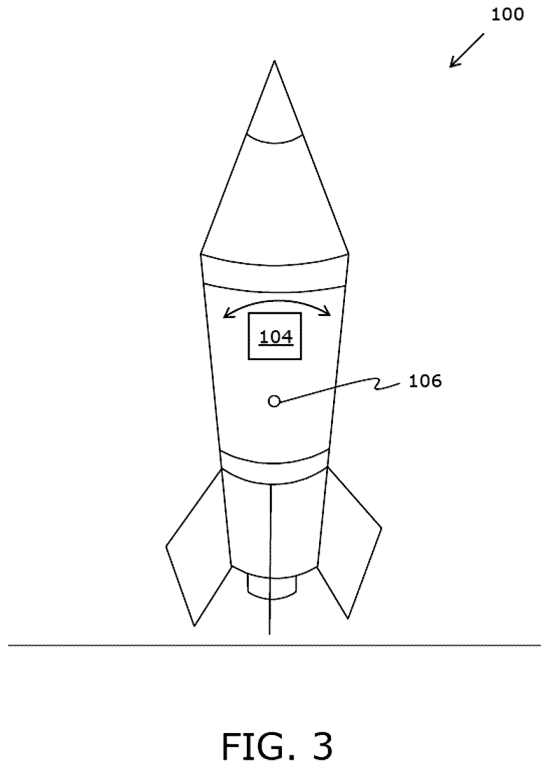

Referring to FIG. 3, there is shown a schematic illustration of the vehicle 100, in accordance with an embodiment of the present disclosure. Herein, the chamber arrangement 104 is configured to be angularly adjustable with respect to the centre of gravity 106 of the vehicle 100 for steering the vehicle 100.

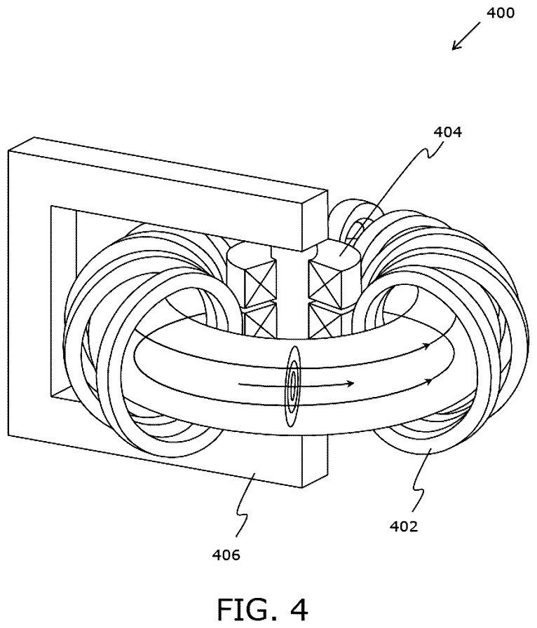

Referring to FIG. 4, there is shown a schematic illustration of a tokamak ring-shaped chamber 400, in accordance with an embodiment of the present disclosure. As shown in FIG. 4, the tokamak ring-shaped chamber 400 is shaped in the form of a ring or a torus, wherein toroidal field coils 402 are helically wound around the torus to induce a magnetic field along the annular central magnetic axis thereof. The tokamak ring-shaped chamber 400 further comprises a primary winding 404 and a transformer yoke 406.

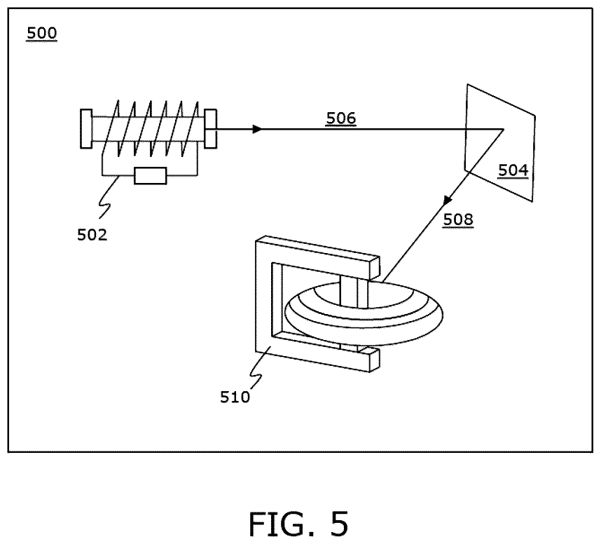

Referring to FIG. 5, there is shown a schematic illustration of a propulsion arrangement 500, in accordance with an embodiment of the present disclosure. The propulsion arrangement 500 comprises a laser arrangement 502, a target 504 that is configured to be stimulated by a laser beam 506 generated by the laser arrangement to produce the antimatter 508, and a deflector arrangement that is configured to guide the antimatter 508 generated at the target 504 into the chamber arrangement, such as the tokamak ring-shaped chamber 510. The laser arrangement 502 includes one or more Q-switched lasers that are configured to generate light pulses that cause the antimatter 508 to be generated in the target 504. The target 504 may be manufactured using Gold, Erbium or Tantalum, although other heavy elements can alternatively be used.

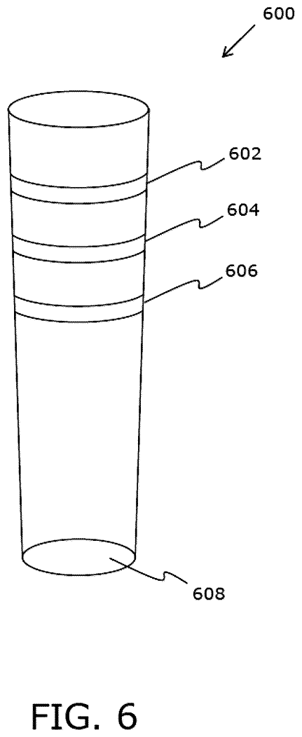

Referring to FIG. 6, there is shown a schematic illustration of a buffer-gas trap 600, in accordance with an embodiment of the present disclosure. The buffer-gas trap 600 is implemented as a modified Penning-Malmberg trap comprising a series of cylindrically symmetric electrodes, such as the electrodes 602, 604 and 606, of varying inner diameters. The electrodes 602, 604 and 606 form three distinct trapping stages with three distinct pressure regions, and confine the antimatter axially by producing electrostatic potentials. Furthermore, the target 608, for example, a Gold, Erbium or Tantalum target, is spatially integrated with the buffer-gas trap 600. Notably, the antimatter generated at the target 608 are consequently transferred to the buffer-gas trap for storage.

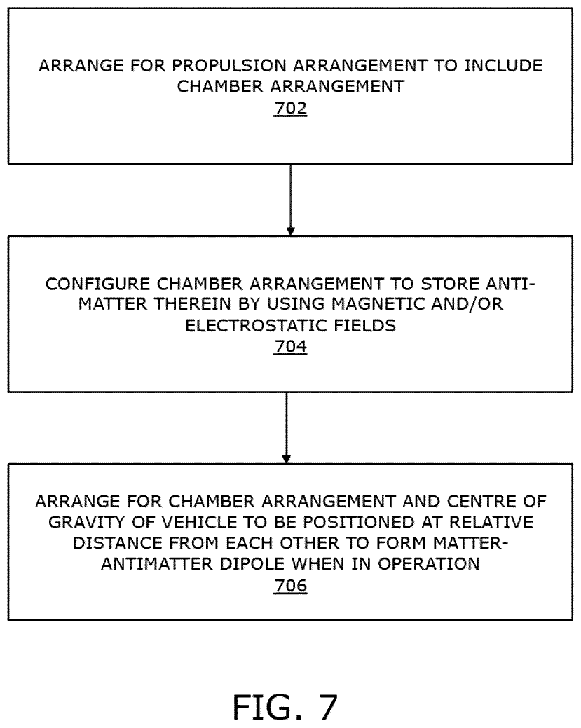

Referring to FIG. 7, there is illustrated a flowchart depicting steps of a method for propelling a vehicle, in accordance with an embodiment of the present disclosure. The vehicle (such as the vehicle 100 of FIG. 1) comprises a propulsion arrangement (such as the propulsion arrangement 102 of FIG. 1). At a step 702, the propulsion arrangement is arranged to include a chamber arrangement. At a step 704, the chamber arrangement is configured to store positrons therein by using magnetic and/or electrostatic fields. At a step 706, the chamber arrangement and a centre of gravity of the vehicle are arranged to be positioned at a relative distance from each other to form a matter-antimatter dipole when in operation. The matter-antimatter dipole provides a propulsion force to the vehicle

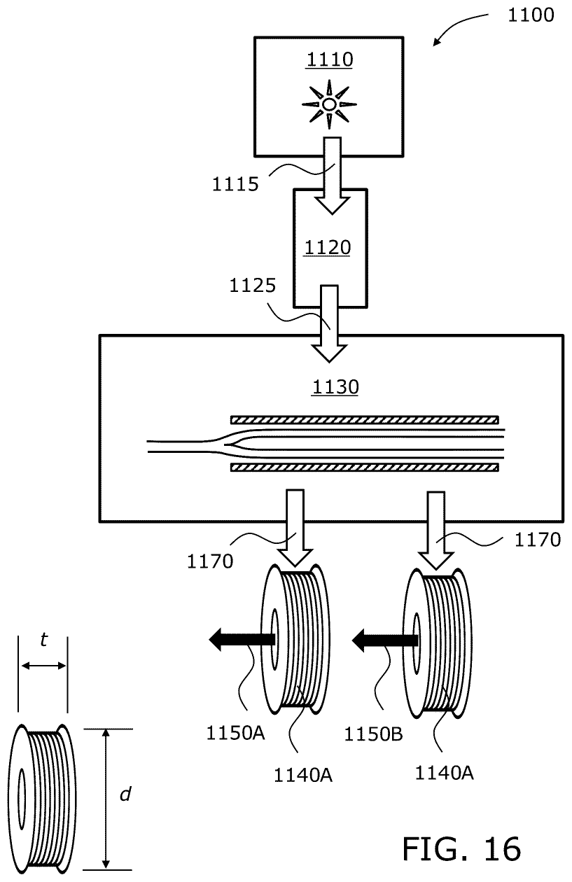

Referring next to FIG. 16, there is shown a schematic illustration of component parts of an apparatus for generating a propulsion force; the apparatus is indicated generally by 1100. The apparatus 1100 includes a laser arrangement 1110 for generating at least one output light beam 1115 comprising photons; for example, the laser arrangement 1110 includes one or more lasers that are configured to function in a pulsed mode of operation. Optionally, the one or more lasers are implemented as one or more solid-state lasers, for example generating photons have a wavelength in a range of 250 nm to 4 μm.

Moreover, the apparatus 1100 further optionally includes a mode coupler 1120 that is coupled to receive the at least one beam 1115 from the laser arrangement 1110 and to provide a corresponding mode-filtered output beam 1125 to a waveguide arrangement 1130 of the apparatus 1100. Optionally, the mode coupler is implemented as one or more grating couplers. Optionally, the one or more gating couplers are fabricated onto a same substrate as used for the waveguide arrangement 1130. When the mode coupler 1120 is omitted, the laser arrangement 1110 provides the at least one beam 1115 directly to the waveguide arrangement 1130. When the mode coupler 1120 is included, the waveguide arrangement 1130 is configured to receive the mode-filtered output beam 1125 and to spatially separate photons thereof into corresponding electrons and positrons, namely to spatially separate the mode-filtered output beam 1125 received thereat into:
(i) a corresponding coherent positron-rich light beam for propagating coherently via an intermediate coupling optical fibre waveguide 1170 to a first optical waveguide coil 1140A; and
(ii) a corresponding coherent electron-rich light beam for propagating coherently via an intermediate coupling optical fibre waveguide 1170 to a second optical waveguide coil 1140B.

The waveguide arrangement 1130 is beneficially configured to support propagation of preferred optical modes therein, for example propagation of Bloch optical modes therein. Moreover, the waveguide arrangement 1130 is fabricated from a non-linear optical material that exhibits, for example, an optical Kerr effect that spatially separates photons propagating therein into corresponding positrons and electrons, while preserving coherence of the photons. For example, the non-linear optical material is beneficially bulk Lithium Niobate, alternatively Lithium-Niobate-On-Insulator (LNOI, TFLN).

The coils 1140A, 1140B beneficially each comprise one or more turns of monomode optical fibre; for each coil 1140A, 1140B, the monomode optical fibre thereof is configured as a closed etalon loop with a spliced optical coupler 1176 included in the loop for injecting positron-rich light or electron-rich light, as appropriate, via its corresponding intermediate coupling optical fibre waveguide 1170. The positrons and electrons are preserved from annihilation or recombination within the optical fibre of the coils 1140A, 1140B by way of their corresponding photons being able to propagate coherently around the respective etalon loops of the coils 1140A, 1140B. The waveguide arrangement 1130 and the coils 1140A, 1140B form an optical system that, when in operation, provides given optical dispersion characteristics, wherein the operation characteristics include two distinct optical dispersion states, wherein one of the optical dispersion states favours electrons (matter) and the other of the optical dispersion states favours positrons (antimatter). Such optical dispersion states are described in more detail in the aforesaid published research paper “Optical diametric drive acceleration through action-reaction symmetry breaking” Wimmer et al., Nature Physics, October 2013, DOI: 101038/NPHYS2777.

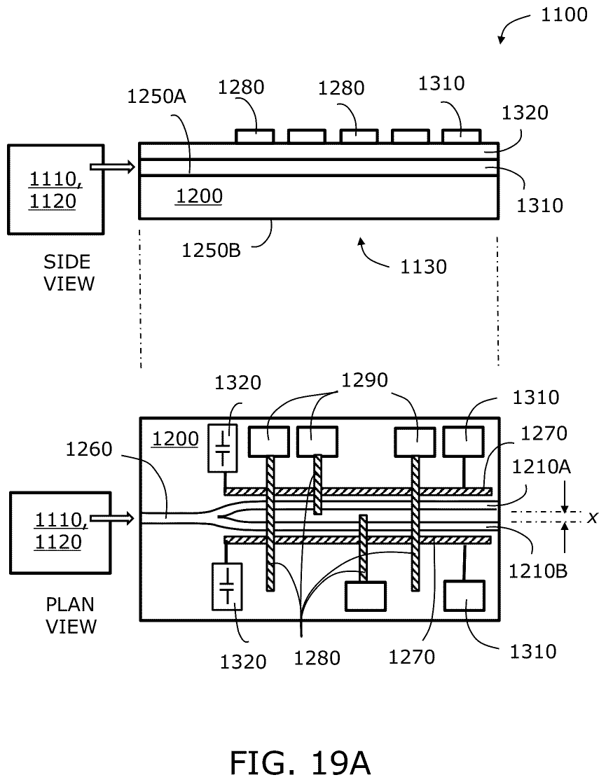

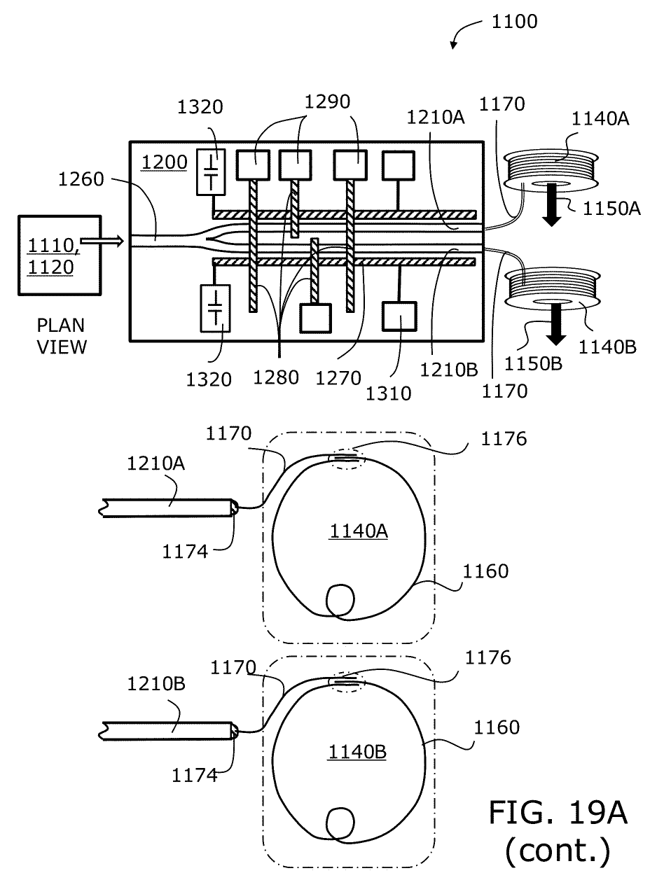

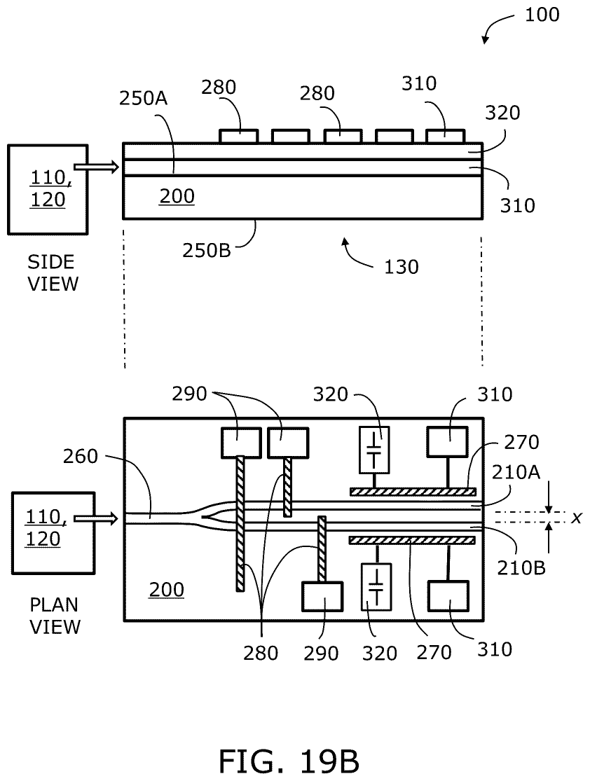

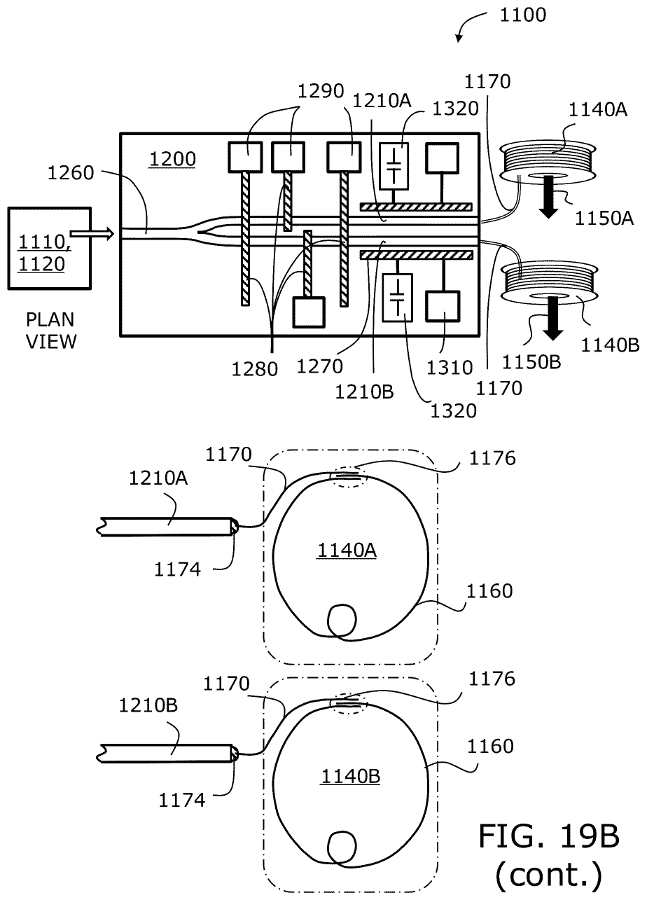

A difference in enhanced positron concentration in the coil 1140A and enhanced electron concentration on the coil 1140B gives rise to a positron-electron dipole, namely a matter-antimatter dipole, that provides propulsion forces as denoted by 1150A, 1150B in FIG. 16, mutatis mutandis in FIGS. 19A, 19B. On account of the positrons having a negative mass, the symmetry of Newton's third law of motion (that pertains to positive masses) is violated (by asymmetry), such that the forces 1150A, 1150B are directed in a mutually same direction and thereby give rise to an aggregate propulsion force, for example for use in propelling a vehicle for space.

Optionally, the mode coupler 1120, for example when implemented as one of more grating couplers, is integral to the waveguide arrangement 1130. Optionally, the laser arrangement 1110, the mode coupler 1120 and the waveguide arrangement 1130 are mounted on a mutually common package, for example onto an integrated circuit header (namely, in a manner of a photonics integrated circuit (PIC)). However, alternative mounting arrangements may be used, for example forced-fluid-cooled heatsink assemblies and so forth, for example depending on a magnitude of the aggregate propulsion force that is to be generated in use by the apparatus 1100.

The apparatus 1100 is of advantage in that it is potentially compact and lightweight, for example of similar size to an optical fibre inertial navigation system (INS) as used in conventional submarines, missiles, aircraft and robotic vehicles. Moreover, the apparatus 1100 avoids a need for using a vacuum system for storing the positrons and electrons to form the matter-antimatter dipole. Moreover, the apparatus 1100 is able to generate a propulsion force without a need to eject matter as in a conventional action-reaction rocket motor.

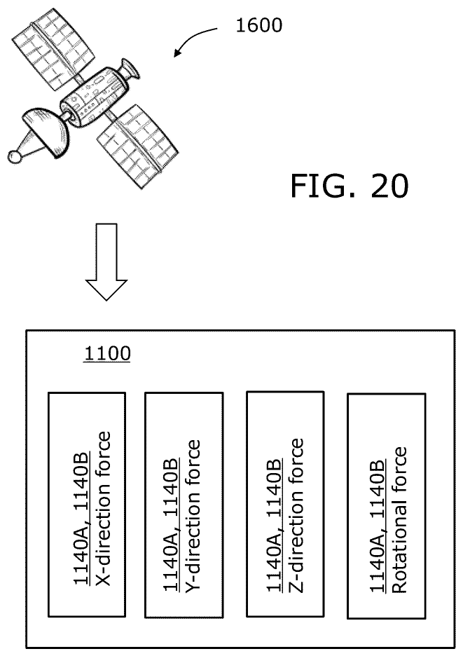

A plurality of the apparatus 1100 may be configured together to provide propulsion in a plurality of directions, for example for steering a vehicle in space, for de-spinning a vehicle in space, for linearly accelerating or decelerating a vehicle 1600 in space and so forth, for example as illustrated in FIG. 20.

Next, component parts of the apparatus 1100 will be described in greater detail with reference to FIGS. 16 to 19A, 19B.

The two coils 1140A, 1140B may be optionally wound onto a mutually same bobbin, wherein the coil 1140A is wound onto a first spatial region of the bobbin and the coil 1140B is wound onto a second spatial region of the bobbin. Optionally, each coil 1140A, 1140B includes several kilometres length of optical fibre 1160 wound therein, for example in a range of 100 metres to 10 km length. Optionally, the first and second regions may be partially overlapping, alternatively spatially separate. Optionally, the bobbin is forced fluid cooled when the apparatus 1100 is configured to generate a considerable aggregate propulsion force. Moreover, the bobbin is beneficially robustly attached, for example by mounting bolts or welds, to a structural frame of the vehicle (for example a rocket or missile).

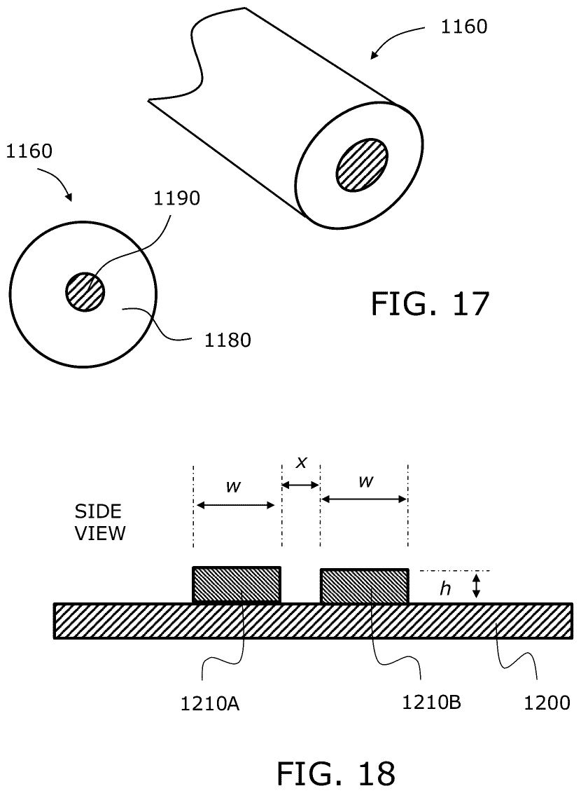

The optional fibre (fiber) 1160 to be used for manufacturing the coils 1140A, 1140B is shown in FIG. 17. The fibre 1160 is configured to be a monomode fibre for photon wavelengths that are used in the apparatus 1100. For example, the optical fibre 1160 is configured to support propagation of photons therein, wherein the photons have a wavelength within a range of 500 nm to 2000 nm, more optionally approximately 530 nm (green colour, green color), more optionally within a range of 1400 nm to 1700 nm, and yet more optionally substantially 1540 nm. A wavelength of substantially 1500 nm is used in the contemporary telecoms industry, enabling manufacturing of the apparatus 1100 to benefit from standard off-the-shelf optical telecoms components. The fibre 1160 is manufactured from high-purity Silica having a sufficiently low defect density, such that photons are able to propagate around the loops of the coils 1140A, 1140B without losing coherence. The fibre 1160 includes an inner core 1190 that is circumferentially surrounded by an outer sheath 1180, wherein the inner core 1190 has a higher refractive index than the outer sheath 1180, wherein photons are able to propagate substantially along the inner core 1190. The inner core 1190 has a radius in an order of a few micrometres, whereas the outer sheath 1180 has a radius of at least 100 micrometres.

As aforementioned, the two coils 1140A, 1140B are each beneficially a closed etalon loop, such that the two coils 1140A, 1140B are each configured to function as an optical cavity or etalon in which photons are able to circulate while experience a low loss of energy and a low conversion from one mode to another, for example energy loss of less than 1 dB per kilometre length of optical fibre.

When in use in the apparatus 1100, the coils 1140A, 1140B are optionally mutually spaced apart by a distance in a range of 10 cm to 10 metres, for example 30 cm, for example to allow for efficient cooling of the coils 1140A, 1140B when the apparatus 1100 is designed to provide appreciable aggregate force, for example tens of thousands of Newtons force for accelerating a missile. Moreover, the coils 1140A, 1140B beneficially have a diameter “d” in a range of 20 mm to 30 cm and a height “t” in a range of 5 mm to 20 cm. Other sizes for the diameter d and the height t may be optionally used. Optionally, the coils 1140A, 1140B are mutually similar in size; alternatively, the coils 1140A, 1140B are mutually different in size. Beneficially, the coils 1140A, 1140B are manufactured to use mutually similar types of optical fibre. Optionally, each coil 1140A, 1140B includes a length of the fibre in a range of 100 metres to 10 km. As aforementioned, the coils 1140A, 1140B have mutually different lengths of the optical fibre 1160 wound thereon.

The laser arrangement 1110 of the apparatus 1100 beneficially includes one or more lasers, for example one or more solid-state lasers that are configured to function as one or more pulsed lasers, for example one or more solid-state picoSecond pulsed lasers. The one or more lasers may, for example, be implemented using solid-state diode lasers, for example one or more proprietary HFL lasers manufactured by RPMC Lasers Inc., https://www.rpmclasers.com/product/1-5um-pulsed-fiber-lasers/; however, it will be appreciated that alternative laser products that may be used to implement the laser arrangement 1110 are provided by other manufacturers at various beam output powers. Such solid-state pulsed lasers are capable of functioning in a photon wavelength range of 1540 nm to 1560 nm, with a pulse duration in a range of 400 picoSeconds to 50 nanoSeconds, with a maximum average power dissipation of 150 Watts, and with a pulse energy of up to around 0.1 milliJoules. High-power solid-state lasers or arrays of multiple such solid-state lasers (for example, operating at approximately 530 nm wavelength) may optionally be used to implement the laser arrangement 1110, for example when greater propulsion forces are required to be generated by the apparatus 1100. The pulses beneficially include photons having electric fields that are sufficiently large in magnitude to induce non-linear optical effects in the waveguide arrangement 1130 when the photons are propagating therein.

The waveguide arrangement 1130 is beneficially manufactured from a non-linear optical material, for example exhibiting a non-linear optical effect such as the Kerr effect. The non-linear optical material beneficially includes at least one of: Lithium Niobate, Lithium Niobate on insulator (LNOI, TFLN), Copper-doped bulk Lithium Niobate, Barium Titanate, Barium Niobate, Graphene, doped Graphene and so forth. Conveniently, the waveguide arrangement 1130 is supported on a substrate that is manufactured from a dielectric material, for example from Silicon Carbide, silica, quartz, sapphire or similar. Conveniently, optionally, the waveguide arrangement 1130 is supported on a substrate such as monocrystalline Silicon or poly-crystalline Silicon.

In the waveguide arrangement 1130, there is included a configuration of waveguides, for example the waveguides 1210A, 1210B, wherein photons supplied from the laser arrangement 1110 propagate to the configuration of waveguides 1210A, 1210B, for example via the mode coupler 1120 when included. The mode coupler 1120 may be beneficially implemented using at least one of: one or more diffraction gratings, one or more grating couplers, one or more lenses, one of more tuned etalons and so forth; for example, the mode coupler 1120 may be used to adjust finely an injection angle of photons into the waveguides 1210A, 1210B, to assist to control generation of regions of electrons, mutatis mutandis regions of positrons. It will be appreciated that the one or more beams provided by the laser arrangement 1110 may include a plurality of different modes that are mutually superimposed, wherein the plurality of modes potentially cause decoherence of photons of the one or more laser beams when propagating in the waveguide arrangement 1130; careful design of the laser arrangement 1110 and waveguide arrangement 1130 is required to avoid unwanted optical modes being propagated that may potentially degrade operation of the apparatus 1100. The mode coupler 1120 is beneficially configured to selectively transmit (namely filter by selective transmission) only radiation of certain optical modes to the waveguide arrangement 1130, for example radiation that propagates as Bloch modes, for example Floquet-Bloch modes, within the waveguide arrangement 1130. When radiation of Bloch modes propagates in the non-linear optical material of the configuration of waveguides of the waveguide arrangement 1130, positrons and electrons of photons are more efficiently spatially separated into groups of positrons and electrons that may be selectively directed to their respective coils 1140A, 1140B. For example, the mode coupler 1120 is configured to adjust an angle of injection of photons into the configuration of waveguides 1210A, 1210B of the waveguide arrangement 1130, wherein the angle of injection is selected to enhance, for example optimize, spatial separation of positrons and electrons within the waveguide arrangement 1130. There is thereby generated a matter-antimatter dipole in the coils 1140A, 1140B, when the apparatus 1100 is in operation.

The waveguide arrangement 1130 may include a configuration of mutually parallel waveguides 1210A, 1210B, for example in a range of two to five hundred such waveguides. The configuration beneficially includes at least two waveguides, optionally more than ten such waveguides. The at least two waveguides 1210A, 1210B may be linear in their plan view; alternatively or additionally, the at least two waveguides 1210A, 1210B may be curved in their plan view, for example two waveguides 1210A, 1210B may be formed into a loop structure including a closed circular optical path on the substrate 1200. The looped waveguide structure is fabricated so that a given photon wavefunction is coherently maintained when its corresponding positron and electron are circulating around the circular path, thereby avoiding annihilation of its positron with matter constituting the waveguide structure. As illustrated, the waveguide structure is beneficially implemented by using at least two optical waveguides 1210A, 1210B that are formed spatially sufficiently closely together in a parallel configuration on a substrate 1200, for example as illustrated in FIG. 18, such that a given photon is able to spatially coherently encompass the at least two waveguides 1210A, 1210B. Typically, the at least two waveguides 1210A, 1210B are spatially separated by a distance “x” which is comparable to, or less than, a wavelength of a photon wavefunction of photons propagating in operation along the at least two waveguides 1210A, 1210B. A height “h” is beneficially in a range of 50 nm to 200 nm, wherein “h” is chosen to suppress mode conversion of photons in the waveguide structure away from, for example, Bloch modes to other less-efficient modes that for which photons are not efficiently spatially separated into corresponding positrons and electrons while maintaining photon coherence. A waveguide width “w” is chosen to accommodate coherent and efficient propagation of photons along the waveguides 1210A, 1210B; for example, the width “w” is comparable to a wavelength of the photons; for example, the width “w” is in a range of 500 nm to 3000 nm.

Conveniently, electrodes formed in the substrate 1200, that are configured alongside the waveguides 1210A, 1210B of waveguide structure, are used to collect energy, for example by Coulombic capacitive coupling, from the positrons and electrons propagating along the waveguides 1210A, 1210B, wherein bunching of the matter-antimatter dipoles is achieved by using appropriate control signals applied to electrodes that are disposed orthogonally to the waveguide structure. The circular path thereby effectively becomes a resonant cavity for the matter-antimatter dipoles from which energy may be coupled out, to provide an electrical output signal, for example for providing power to the laser arrangement 1110. It will be appreciated that the aforesaid optical Kerr effect causes photons to be separated spatially to cause distinct regions that are rich in electrons and positrons to be formed (using well known laws of physics as described in aforesaid Wimmer et al.), thereby causing spatial segregation of electrons with other electrons, and positrons with other positrons to occur in the waveguide structure. Conveniently, the substrate 1200 is optionally fabricated from a dielectric material, for example from silica, quartz, sapphire or similar, and the waveguide structure is fabricated from an optically transmissive material that exhibits the aforesaid optical Kerr effect, for example Lithium Niobate, Lithium Niobate on insulator (LNOI, TFLN), Barium Titanate, Barium Niobate, Graphene, doped Graphene and so forth. Optionally, the substrate 1200 may be fabricated, at least in part, from Silicon, for example mono-crystalline or poly-crystalline Silicon, to provide satisfactory structural robustness and also removal of heat generated in the waveguides 1210A, 1210B when in operation.

The substrate 1200 and its corresponding components parts, as described in the foregoing, may be configured in plural form, namely in arrays to generate a larger aggregate force for propulsion. Optionally, the one or more lasers of the laser arrangement 1110 are integrated into a same package as the substrate 1200.

The implementation, namely the apparatus 1100 as illustrated in FIG. 16, is elucidated in the foregoing in overview. Next, a detailed reduction-to-practice of the apparatus 1100 will be described.

Referring next to FIG. 19A, there is shown an illustration of an apparatus 1100. The apparatus 1100 includes at least one substrate 1200, for example a plurality of such substrates 1200. The at least one substrate 1200 is manufactured from a dielectric material, for example Silicon, silica, fused silica, quartz, sapphire, a ceramic material, or similar. The at least one substrate 1200 is beneficially a planar element having an upper planar surface 1250A and a lower planar surface 1250B. The at least one lower planar surface 1250B is usable to support the at least one substrate 1200 mechanically. The at least one substrate 1200 is beneficially, optionally, in a range of 0.5 mm to 3 mm thick. The upper planar surface 1250A is manufactured to a mirror finish, as required for the fabrication of microelectronic devices through use of microlithographic processes. During manufacture, a layer of optical material is formed, for example by bonding or using vapour phase deposition, on the upper planar surface 1250A, wherein the optical material is patterned using one or more microlithographic processes to form an input waveguide structure 1260, and also the waveguides 1210A, 1210B that are optically coupled at their first ends to the input waveguide structure 1260, and are coupled at their second ends, at a peripheral edge of the substrate 1200, to intermediate monomode optical fibres 1170 via use of a UV-curable optically transparent adhesive 1174 that has a substantially similar refractive index to a material of the waveguides 1210A, 1210B and to a central core 1190 of the intermediate monomode optical fibres 1170; during manufacture of the apparatus 1100, the central cores 1190 of the intermediate monomode fibres 1170 are spatially aligned to their respective second ends of the waveguides 1210A, 1210B, after which the aforesaid UV-curable adhesive 1174 is applied and UV-set to become a solid optically-transparent coupling material, mechanically coupling the intermediate fibres to their respective waveguides 1210A, 1210B.

The intermediate monomode optical fibres 1170 are configured to convey photons and excess electrons, alternatively photons and excess positrons to their respective coils 1140A, 1140B.

Optionally, the aforesaid layer of optical material used in manufacture includes at least one of: Lithium Niobate, Copper-doped bulk Lithium Niobate, Lithium-Niobate-on-insulator (LNOI, TFNL), Barium Titanate, Barium Niobate, Graphene, doped Graphene or any other material that exhibits a non-linear optical effect, in particular the optical Kerr effect that functions to segregate photons into their corresponding regions electrons and photons within a spatial envelope of their corresponding Schrödinger wavefunctions; the optical material is thereby referred as being a “non-linear optical material”. The layer of optical material used is beneficially in a range of 50 nm to 3 μm thick to allow for reactive ion etching (RIE) or wet chemical etching through a lithographically-defined resist during manufacture.

The input waveguide structure 1260 is used to couple photons from the laser arrangement 1110, for example transmitted via the mode coupler 1120. As aforementioned, the mode coupler 1120 may be optionally implemented using one or more optical grating couplers formed onto the substrate 1200. As a yet further alternative or addition to using the input waveguide structure 1260 to inject photons into the waveguides 1210A, 1210B, the substrate 1200 may be illuminated in use with photons from above the waveguide structure, for illuminating the waveguides 1210A, 1210B with an evanescent optical beam that skims the upper planar surface 1250A. The photons may be generated from one or more lasers of the laser arrangement 1110, for example one or more pulsed lasers; optionally, the one or more lasers are packaged together integrally with the substrate 1200 in a protective enclosure, for example a canned semiconductor DIL-type or a PIC-type package. As another example, the substrate 1200 may be mounted between a pair of planar mirrors whose planes are mutually substantially parallel and are substantially orthogonal to a plane of the upper planar surface 1250A; optionally, the mirrors are slightly curved to distribute light generated by the one or more lasers of the laser arrangement 1110; optionally, the mirrors are implemented as a single cylindrical mirror encompassing the substrate 1200; the plane mirrors form an optical cavity in which the substrate 1200 is mounted in use and is bathed in an intense photon flux generated from at least one of: one or more lasers of the laser arrangement 1110, alternatively or additionally collected solar radiation. Thus, photons for the apparatus 1100 may thus, for example, be provided from collected solar radiation.

As aforementioned, the two waveguides 1210A, 1210B are fabricated from a thin layer, for example less than 200 nm thick, more optionally less than 100 nm thick, of non-linear optical material, for example Lithium Niobate, Copper-doped bulk Lithium Niobate, Barium Titanate, Barium Niobate, Graphene, doped Graphene and so forth; the non-linear material is chosen to exhibit the optical Kerr effect when in use that causes photons present in the waveguides 1210A, 1210B to spatially separate into corresponding electrons and positrons (see aforementioned Wimmer et al. research paper that is based on well-known laws of physics, for more details). Optionally, the waveguides 1210A, 1210B are mutually differently doped, for example one of the waveguides 1210A, 1210B is n-type doped and the other waveguide 1210A, 1210B is p-type doped, to enhance spatial segregation of photons between the waveguides 1210A, 1210B, to form matter-antimatter dipoles; such doping assists to define the aforesaid two optical dispersion states. The distance x is sufficiently small, such that a coherence of photon propagation is maintained between the waveguides 1210A, 1210B, for photons and their corresponding matter-antimatter dipoles propagating therealong.

Thus, the waveguides 1210A, 1210B exhibit the optical Kerr effect, that results in photons spatially separating out into a surplus of electrons propagating along one of the waveguides 1210A, 1210B, for example the waveguide 1210A, and a surplus of positrons propagating along the other of the waveguides 1210A, 1210B, for example the waveguide 1210B. This spatial separation occurs while the wavefunctions of the photons have a spatial extent that includes both of the waveguides 1210A, 1210B, thereby preventing the positrons of the photons annihilating with the waveguides 1210A, 1210B. The spatial separation of the electrons and their respective positrons creates corresponding matter-antimatter dipoles that are able to propagate along the waveguide arrangement 1130; on account of the dipoles being able to create a force that is moving, energy may be optionally extracted from the substrate 1200 and its associated structures. For such purpose, electrodes 1270 are disposed alongside the one of the waveguides 1210A, 1210B that have excess electrons; the electrodes 1270 enable power to be extracted by Coulombic capacitive coupling to generate an electrical output signal. Optionally, the electrodes 1270 are included only along a portion of the length of the waveguides 1210A, 1210B, for example towards ends of the waveguides 1210A, 1210B, remote from the input waveguide structure 1260, namely as illustrated in FIG. 19B. In FIGS. 19A and 19B, further electrodes 1280 are disposed orthogonally to the waveguides 1210A, 1210B, wherein the electrodes 1280 are optionally insulated from the electrodes 1270 by a dielectric layer such vapour-phase-deposited Silicon Dioxide, where they mutually overlap. The further electrodes 1280 are optionally used as control electrodes to modulate movement of the matter-antimatter dipoles to arrange them into bunches to create oscillations of dipole density propagating along the waveguide structure 1130; the further electrodes 1280 either straggle both of the waveguides 1210A, 1210B, or only one of the waveguides 1210A, 1210B. The oscillations allow for the aforesaid Coulombic capacitive coupling of electrons and positrons to the electrodes 1270 to generate the electrical output signal. Positrons and electrons that are mutually spatially separated in the waveguides 1210A, 1210B are coupled from open ends of the waveguides 1210A, 1210B (namely “second ends”) into the intermediate optical fibres 1170 that are in turn coupled to the coils 1410A, 1410B.

Next, operation of the apparatus 1100 will be described with reference to FIGS. 19A, FIG. 19B. In operation, the electrodes 1280 are used to control separation of the photons between the waveguides 1210A, 1210B into regions of excess electrons and excess positrons in combination with the optical Kerr effect, as well as controlling a direction of propagation of photons along the waveguides 1210A, 1210B, and also control bunching of the photons along the waveguides 1210A, 1210B, so that the electrodes 1270 are most efficiently able to couple capacitively to charges developed along the waveguides 1210A, 1210B to generate the aforesaid electrical output signal corresponding to electrical energy extracted from the apparatus 1100. Optionally, when the apparatus 1100 is provided with photons from the aforesaid one or more lasers of the laser arrangement 1110, the one or more lasers are beneficially operated in a pulsed mode; optionally, control signals applied to the electrodes 1280 are d.c. bias potentials to generate electric fields longitudinally along the waveguides 1210A, 1210B; alternatively, optionally, the control signals applied to the electrodes 1280 are temporally synchronized to pulses of the one or more lasers. In particular, the control signals applied to the electrodes 1280 are beneficially arranged to slightly retard electrons propagating along the waveguides 1210A, 1210B and accelerate positrons propagating along the waveguides 1210A, 1210B, so that both the electrons and positrons mutually self-accelerate along the waveguides 1210A, 1210B, thereby enhancing a magnitude of the output signal generated at the electrodes 1270. At least one of the aforesaid bunching and the one or more lasers being operated in pulse modes, assists electrical energy coupling of electrons and positrons from the waveguides 1210A, 1210B to the electrodes 270. However, it will be appreciated that more than the aforesaid two waveguides 1210A, 1210B may be used in the apparatus 1100. At least a portion of the energy collected at the electrodes 1270, namely signal pulses that are Coulombically capacitively coupled to the electrodes 1270, may be fed back, for example via a rectifying circuit including one or more diodes (not shown), to provide operating power, for example d.c. electrical power, to the laser arrangement 1110, as aforementioned.

Beneficially, the electrodes 1270 are optionally coupled to a capacitor arrangement 1320, for example implemented as a chip capacitor that is flip mounted to the substrate 1200. Moreover, for a cycle of operation, the one or more lasers of the laser arrangement 1110 are beneficially operated in a given pulse mode, wherein the capacitor arrangement 1320 is set to a starting potential prior to the one or more lasers being pulsed; photons provided from the one or more lasers are pulsed and propagate to the waveguide arrangement 1130, wherein the photons are spatially separated into corresponding electrons and positrons on account of the non-linear optical Kerr effect, thereby forming corresponding matter-antimatter dipoles that propagate along the waveguide arrangement 1130, wherein the matter-antimatter dipoles accelerate; accelerated electrons of the matter-antimatter dipoles are coupled to the electrodes 1270 and charge the capacitor arrangement 1320. Beneficially, after the pulses of the one or more lasers have ceased, the capacitor arrangement 1320 is discharged to extract energy therefrom to provide energy output from the apparatus 1100, for example back energize the laser arrangement 1110, wherein the capacitor arrangement 1320 is returned to the starting potential. Optionally, the cycle is repeated, for example at a repetition rate in excess of 100 MHz.

On account of the apparatus 1100 utilizing the substrate 1200 manufactured from an environmentally benign dielectric material, the apparatus 1100 is environmentally friendly in its manufacture, and does not give rise to toxic and dangerous by-products when in operation, for example greenhouse gas emissions such as Carbon Dioxide. Thus, use of the apparatus 1100 is capable of reducing Carbon Dioxide emissions to the atmosphere, thereby mitigating anthropogenically-forced climate change. As the substrate 1200 is optionally beneficially manufactured from silica or quartz, made essentially from types of sands, the apparatus 1100 may be manufactured from materials that are plentifully available to industry, namely using sustainable technology.

Optionally, for the aforesaid apparatus 1100, the substrate 1200 is mounted on a major plane of a magnet arrangement, for example a flat planar Neodymium magnet, whose magnetic field lines are arranged to be orthogonal to a plane of the substrate 1200. Beneficially, the magnetic field lines assist the non-linear characteristics of the apparatus 1100, to cause separation of the photons into their respective electrons and positrons in the at least two waveguides 1210A, 1210B of the apparatus 1100.

The magnitude of the aforementioned aggregate force generated by the coils 1140A, 1140B is beneficially controlled by at least one of:
(i) varying or adjusting a pulse rate of the one or more lasers of the laser arrangement 1110 used to generate electrons and positrons in the coils 1140A, 1140B;
(ii) varying or adjusting a pulse energy of the one or more lasers of the laser arrangement 1110 used to generate electrons and positrons in the coils 1140A, 1140B; and
(iii) varying or adjusting a matching performance or one or more mode selection characteristics of the mode coupler 1120 controlling a selection of one or more modes transmitted to the waveguide arrangement 1130.

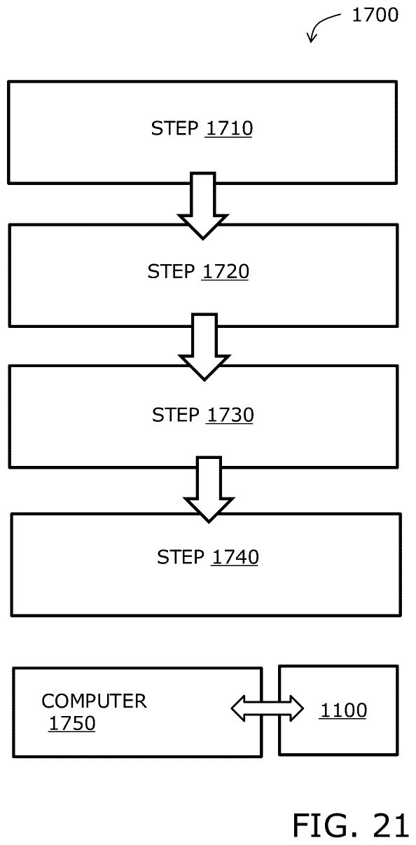

Referring next to FIG. 21, there are shown steps of an algorithm, also referred to as being a method, indicated generally by 1700. Optionally, the algorithm 1700 is beneficially implemented using a computing device (“COMPUTER”) 1750 that is configured to execute a software product recorded on a machine-readable data storage medium. Such control includes operation of the one or more lasers of the laser arrangement 1110, and voltages applied to the electrodes 1270, 1280; it will be appreciated that the one or more lasers may be operated in a pulsed mode, alternatively in a continuous mode, or switchable therebetween. Moreover, potentials applied to the 1270, 1280 may be constant voltages or varied in a pulsed manner, or switchable therebetween.

The algorithm 1700 is used to convert one or more photons at least one of input or generated within the apparatus 1100 into one or more propulsion forces. Beneficially, the algorithm 1700 includes steps 1710 to 1740.

In the step 1710, the algorithm 1700 includes configuring the apparatus 1100 to include at least one substrate 1200 including an operating region, for example the at least two waveguide 1210A, 1210B, in which the one or more photons are able to propagate in use. Optionally, for example, the operating region includes a loop waveguide structure formed on the at least one substrate 1200.

In the step 1720, the algorithm 1700 includes spatially separating the one or more photons to generate corresponding one or more electron-positron matter-antimatter dipoles in the operating region on the substrate 1200, wherein the operating region is configured to support propagation of the one or more matter-antimatter dipoles therearound or therealong when in operation and to divert the positrons and electrons to their respective coils 1140A, 1140B. On account of photons being capable of being coherently propagated around the coils 1140A, 1140B, their respective positrons or electrons are also capable of propagating around the coils 1140A, 1140B without decoherence or annihilation occurring.

In the step 1730, the algorithm 1700 includes arranging for the difference in the number of electrons circulating around one of the coils 1140A, 1140B and a corresponding number of positrons circulating around the other of coils 1140A, 1140B, to generate a matter-antimatter dipole between the coils 1140A, 1140B that gives rise to the aforesaid aggregate propulsion force.

In the step 1730, the algorithm 1700 includes using an energy collection arrangement, for example implemented using the electrodes 1270, 1280 of the apparatus 1100, to extract energy from the propagating one or more matter-antimatter dipoles along the waveguides 1210A, 1210B to generate an electrical output signal; optionally, the electrical output signal may be fed back to provide at least one of: feedback control, at least a portion of electrical power to operate the laser arrangement 1110.

In the optional step 1740, the algorithm 1700 includes configuring the apparatus 1100 to be included in plurality in an array formation. Optionally, the array formation has its multiple apparatus 1100 configured to provide individually-controllable propulsion forces in x, y, z Cartesian axis directions, and also in rotational directions around those Cartesian axes, for example for use in steering and manoeuvring a space vehicle, for example a satellite in orbit.

It is to be understood that arrangements of components illustrated in the aforesaid diagrams and described above are exemplary and that other arrangements may be possible within the scope of the claims as appended herewith. Although the disclosure and its advantages have been described in detail, it is to be understood that various changes, substitutions, and alterations may be made herein without departing from the spirit and scope of the disclosure as defined by the appended claims.

### APPENDIX

The question of whether the photon is an elementary particle or composite has been a matter of debate for almost 100 years since Louis De Broglie published his paper, “A Tentative Theory of Light Quanta” in year 1924. De Broglie wrote “Naturally, the light quantum must have an internal binary symmetry”. The composite theory is more descriptive of reality than the elementary theory. Perkins (year 2014) finds that the composite theory predicts the Maxwell equations, while the elementary photon has been created to reflect them. He continues “In the elementary theory, it is difficult to describe the electromagnetic field with the four-component vector potential. This is because the photon has only two polarization states. This problem does not exist with the composite photon theory.”

Gauthier (year 2019) has done extensive work in this area and elaborates a composite model consisting of an electron-positron pair spinning around each other in helical motion. He finds that the parameters of energy, frequency, wavelength and helical radius of each spin-½, half photon composing the double-helix photon remain the same in the transformation of the half photons into the relativistic electron and positron quantum vortex models. Villata (year 2011) has transformed matter into antimatter in the equations of both electrodynamics and gravitation. Starting from the CPT invariance of physical laws, in the former case, the result is the well-known change of sign of the electric charge. In the latter, he finds that the gravitational interaction between matter and antimatter is a mutual repulsion, namely antigravity appears as a prediction of general relativity when CPT is applied. This result supports cosmological models attempting to explain the accelerated expansion of the Universe in terms of a matter-antimatter repulsive interaction.

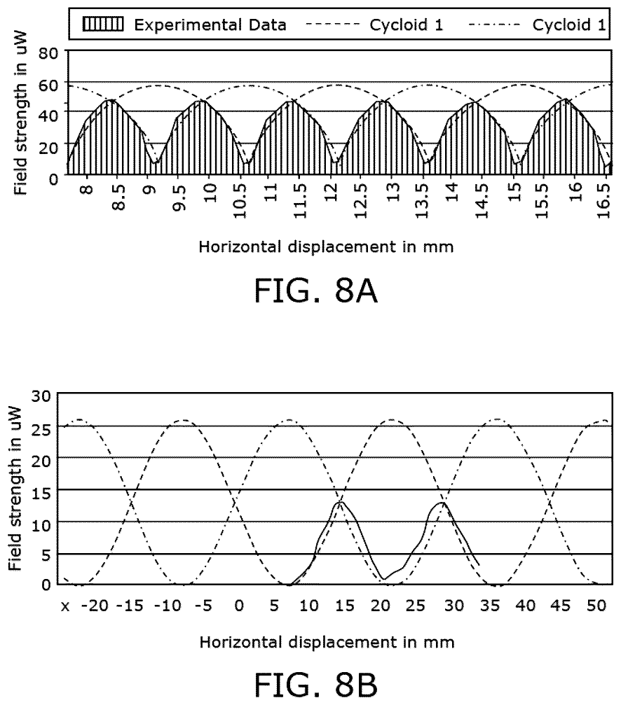

Using the work of Bondi (year 1957), we may interpret this finding as negative mass of the only type compatible with general relativity. The interactions of such negative mass are given in FIG. 8. For the negative mass, the acceleration is in the opposite direction to the gravitational force.

### Experimental Evidence

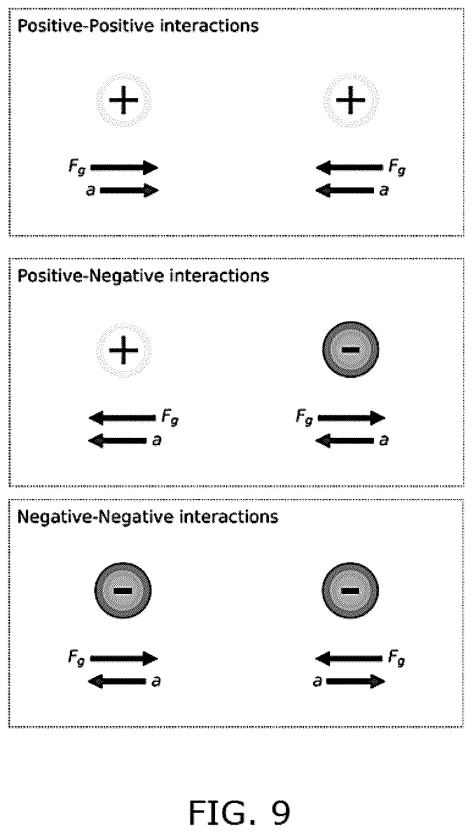

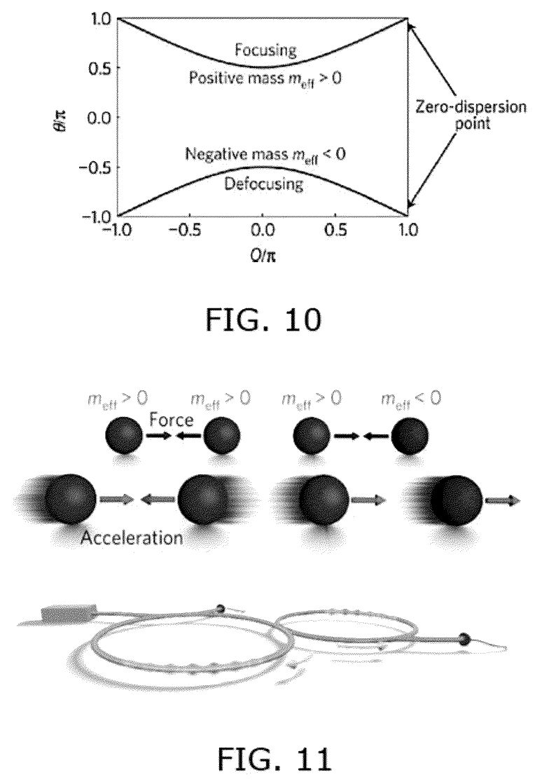

For experimental confirmation of the photon's composition as two symmetrical half-photons, one of positive mass and one of negative mass, we can look to Wimmer, Regensberger et al. (year 2013). They find symmetrical halves of negative and positive mass on a dispersion diagram for light pulses interacting (FIG. 9). The laser pulses also display runaway self-acceleration which is expected from FIG. 8. for the positive-negative mass interaction in which the accelerations of the two masses are in the same direction (FIG. 10).

That the photon consists of an electron with positive and a positron with negative mass explains why the rest mass of the photon is zero. Runaway motion between positive and negative mass explains why photons always travel at light speed.

In the absence of an electrical field, the defocusing behaviour of positron beams is evidence of the negative mass to negative mass interaction. Negative masses accelerate away from each other.

In addition, the elliptical polarization of light is experimental evidence for the composite photon. This shows the electromagnetic field to be a 4-vector. The elementary photon theory predicts only two states of (circular) polarization.

### Charges Follow a Potential Gradient

We do not find, however, that the positron of negative mass will react inversely to the electromagnetic force. This would be inconsistent with experimental evidence for the electromagnetic interaction of antimatter (Gabrielse et al.; year 1999). There is no gravitational potential gradient in spectroscopy experiments to determine the mass/charge ratio of antimatter particles. Since negative mass was completely unexpected, the experimental set-up, which is largely unchanged since year 1897, was not designed to detect it.

### Equality of Forces Acting on the Electron-Positron Pair

We now investigate the forces acting on the electron-positron pair. The centripetal force is equal to the Coulomb force acting between the negatively charged electron and the positively charged positron. In addition, from the arguments above, a repulsive gravitational force between the matter and antimatter particles is equal to the attractive Coulomb force.

We have: Centripetal force=Coulomb force=Gravitational force

For two half-photons separated by a distance

$$D = \frac{λ}{π} ,$$

wherein λ is wavelength of the photon

$$For λ = ϖD , \begin{matrix}{F}_{centripetal} = 2 π \frac{c}{λ} \cdot \frac{1}{2} \cdot \frac{h}{λ} \\ = \frac{π ch}{{λ}^{2}} \\ = \frac{π ch}{{D}^{2} {π}^{2}} \\ = \frac{ch}{{D}^{2} π} \\ = \frac{{Gm}_{e} {m}_{p}}{{D}^{2}} = {F}_{gravitational}\end{matrix}$$

wherein mₚ is mass of a positron

$$G = \frac{ch}{π {m}_{e}^{2}}$$

$${G}_{s} = \frac{2 ℏ c}{{m}_{e}^{2}}$$

This is the Gravitational Constant for strong gravity

This compares to:

$$G = \frac{ℏ c}{{M}_{p}^{2}}$$

For Newton's Gravitational constant, wherein Mₚ=Planck mass

This indicates the existence of a strong version of the gravitational force operating inside the composite photon consisting of an electron-positron pair.

This strong gravitational force is stronger than the Newtonian gravitational force in the ratio:

$$\frac{{G}_{s}}{G} = \frac{2 {M}_{p}^{2}}{{m}_{e}^{2}}$$

Or 45 orders of magnitude stronger than the Newtonian gravitational force. In other words, a small amount of antimatter arranged with matter in an antimatter-matter dipole is capable of generating considerable force to propel a spacecraft.

For consistency, we check:

$${F}_{Coulomb} = {F}_{gravitational}$$

where Q=e²\sqrt{2/α}=16.6e is the magnitude of the charge on each helically moving half photon, α=fine structure constant and ε₀ is the permittivity of the vacuum.

$$\frac{{Q}^{2}}{4 π {ε}_{0} {D}^{2}} = \frac{{G}_{s} {m}_{e}^{2}}{{D}^{2}}$$

$${G}_{s} = \frac{2 {e}^{2}}{4 π {ε}_{0} α {m}_{e}^{2}}$$

$$Since {e}^{2} = 4 π {ε}_{0} ℏ c α = \frac{2 ℏ c}{{m}_{e}^{2}}$$

This confirms the value of the strong gravitational constant, Gs, so the gravitational force becomes equal to the Coulomb force for

$${G}_{s} = \frac{2 ℏ c}{{m}_{e}^{2}} .$$

Note that the value of Gs is independent of the wavelength of the photon. The strong gravitational force acts on all photons, regardless of their energy.

This provides a unification between the electromagnetic force and the gravitational force, at least in the case of the electron-positron pair.

Is this Truly a Unification or Simply an Equivalence?

$${F}_{Coulomb} = {F}_{gravitational}$$

where Q=e²\sqrt{2/α}=16.6e is the magnitude of the charge on each helically moving half photon, α=fine structure constant and so is the permittivity of the vacuum.

$$\frac{{Q}^{2}}{4 π {ε}_{0} {D}^{2}} = \frac{{G}_{s} {m}_{e}^{2}}{{D}^{2}}$$

$$\frac{2 {e}^{2}}{4 π {ε}_{0} α {m}_{e}^{2}} = \frac{{G}_{S} {m}_{e}^{2}}{{D}^{2}}$$

$$\frac{2 {e}^{2}}{{G}_{s} {D}^{2}} = \frac{{m}_{e}^{2} \cdot 4 πα {ε}_{0}}{{D}^{2}}$$

In this representation, we have an electromagnetic force with a gravitational constant is equivalent to strong gravity with an electromagnetic constant.

The two forces are different aspects of the same force, one attractive and the other repulsive.

### Consequences of Aforesaid Insight

The electromagnetic force unifies with the strong gravitational force present in composite photons consisting of an electron-positron pair. This strong gravitational force is 45 orders of magnitude stronger than Newtonian gravity.

This unification provides a framework for the unification of the four fundamental forces of nature since the weak force, electromagnetic force and strong force have already been shown to unify. It provides a potential resolution to the Hierarchy Problem of why Newtonian gravity is so much weaker than the other forces.

The composite photon model developed by Gauthier and augmented here give some deep insights into the process of transformation of light into matter and antimatter and the annihilation process of matter and antimatter into photons.

### Observational Evidence for Antimatter Having Negative Mass

Composite photons consisting of particle-antiparticle pairs having positive and negative mass provide a physical interpretation at the level of particle physics for the Pair Creation Model of the Universe developed by Choi and Rudra (2104). This gives, for the first time, a fully consistent and lucid explanation of how the universe developed from net zero energy and evolved into the distribution of energy density we observe today.

Indeed, the results of Choi and Rudra's simulation correspond closely with observations:

Energy Distribution in the Universe:

| | WMAP | Simulation | Planck |
|---|---|---|---|
| Matter | 4.6 | 4.5 | 4.9 |
| Dark Matter | 23.3 | 25.1 | 26.8 |
| Dark Energy | 72.1 | 70.3 | 68.3 |

Composite photons consisting of particle-antiparticle pairs having positive and negative mass also provide a physical interpretation at the level of particle physics for the gravitational dipoles proposed by Hadjukovic. Support is also given to negative mass cosmologies developed by J. S. Farnes and Choi and Rudra which correspond well to observational evidence of the interactions and behavior of Dark Matter and Dark Energy. The composite photon development given here thus benefits from the same observational evidence which must be contrasted with the absolute failure of experiments to detect Dark Matter particles or Dark Energy in the laboratory.

### Gravity in the Early Universe

$$Strong gravitational force = \frac{{G}_{s} {m}_{e}^{2}}{{D}^{2}} = \frac{2 hC}{2 π {D}^{2}}$$

for the electron-positron pair (the elementary charged particles).

This follows an inverse square law but is independent of the Gravitational constant. It tends to a maximum value of

$${F}_{max} = \frac{2 hc}{2 π {l}_{p}^{2}}$$

as the distance between the electron and positron tends to the Planck length and is repulsive.

$${F}_{max} = \frac{2 hc}{2 π {l}_{p}^{2}} = \frac{2 ℏ c}{ℏ G} \cdot {c}^{3}$$

Where lₚ=Plank length and since

$${l}_{p}^{2} = \frac{ℏ G}{{c}^{3}}$$

$${F}_{max} = \frac{2 {c}^{4}}{G} which is 2 times the Planck Force$$

FIG. 11 presents a picture of the primordial force in the early universe. One force is attractive and one force repulsive. A symmetrical beginning for the universe with net-zero energy. These appear to be different aspects of the same primordial force.

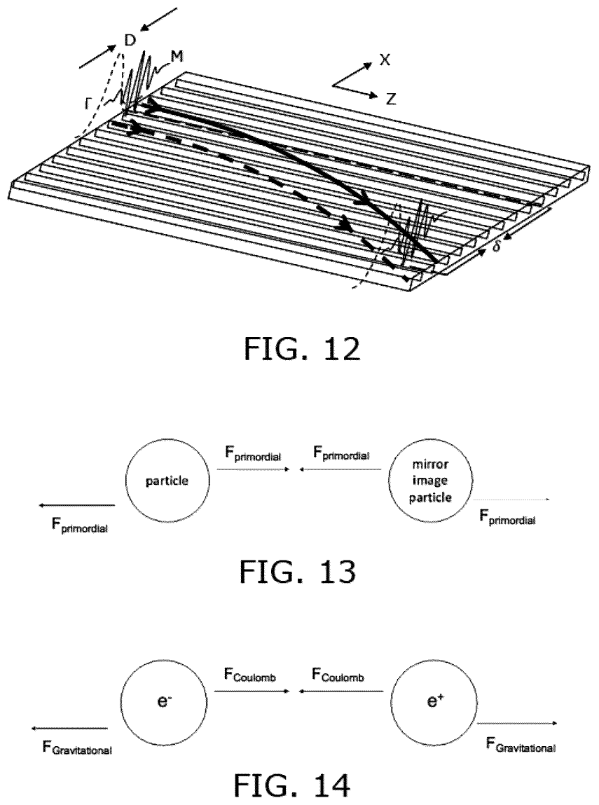

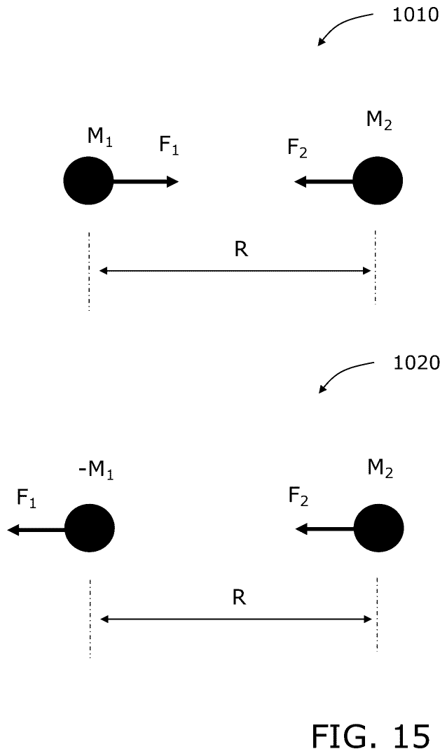

From a human perspective, labels appeared as in FIG. 12. This gives us an understanding of how the Coulomb force and gravitational force are different aspects of the same primordial force.

We may also observe that the form of the Coulomb force and the Gravitational force are the same:

$${F}_{Coulomb} = {F}_{gravitational}$$

$$\frac{{Q}^{2}}{4 π {ε}_{0} {D}^{2}} = \frac{{G}_{s} {m}_{e}^{2}}{{D}^{2}}$$

$$\frac{K . {Charge}^{2}}{{D}^{2}} = \frac{K . {Mass}^{2}}{{D}^{2}}$$

$$Wherein K = constant$$

$$We find {K}^{2} = {( Planck Charge )}^{- 1}$$

A symmetrical beginning for the universe with net-zero energy and particles that are mirror images gives positive and negative electromagnetic charges and positive and negative gravitational charges; positive mass for matter and negative mass for antimatter.

### Unification Energy

Since photons can take on energies across the electromagnetic spectrum, it does not make sense to think of unification taking place at a particular energy level. Unification between the Coulomb force and the gravitational force takes place through a variation in the value of the gravitational constant, which is much higher for the strong gravitational force between the electron and the positron.

The composite photon consisting of a positive mass particle and a negative mass antiparticle allows gravity to be combined with the Standard Model of particle physics for the first time.

### Range of the Strong Gravitational Force

The strong gravitational force discovered here is present in all photons. Since the electromagnetic spectrum covers wavelengths ranging from 100,000 km to 1 picometre, then the force is not microscopic in range but rather operates across a wide range of distances as Newtonian gravity does.

### Expansion of Einstein Field Equations to Include Vector Gravity

We can now contemplate the expansion of Einstein's Field Equations to include the strong gravity found here, which is repulsive between positive mass and negative mass. The deep relationship to Coulomb's Law shown here provides the basis for this expansion.

Tentatively, we can say that an equivalence to Maxwell's equations can be developed since we may now view gravity as gravitational charge having positive and negative charges in the same manner as electromagnetism. We may develop Gauss's law for gravity from Newton's law in the same manner that Gauss's law can be developed from Coulomb's law.

Nieto and Goldman (year 1991) highlight the possibility of vector gravity for antimatter. Their study concludes that experimental evidence does not exclude this outcome.

Gauss's law for gravity gives:

$$∇ \cdot g = 4 \prod {G}_{s} ρ$$

where ∇ is the divergence, g is the gravitational field and ρ is the mass density. Quantities may be positive or negative.

More generally, we note that Maxwell's equations for electromagnetism may be developed from Coulomb's Law plus the Lorenz invariance transformations of Special Relativity. In a parallel manner, an extended version of Einstein's Field Equations can be developed from Newton's Law of Gravitation plus Special Relativity. This extension will include interactions between the positive and negative gravitational charges and reflect the strong gravitational constant calculated here for the interaction between positive and negative mass.

### CONCLUSION

A deep relationship is identified between the Coulomb force and Gravity. We demonstrate how this relationship arises through the composite photon. A gravitational constant for strong gravity is calculated from the relationship. The gravitational force is repulsive between matter having positive mass and antimatter having negative mass. Experimental evidence for the composite nature of the photon and for antimatter having negative mass is presented. The striking equivalence between mass and charge is explored. It is postulated that the Coulomb force and gravity are different aspects of the same primordial force. Implications are given for the expansion of Einstein's Field Equations to include vector gravity.

The APPENDIX here provides a theoretical basis for apparatus described in the foregoing for realising practical workable embodiments of the present disclosure. Component parts of the embodiments are contemporarily commercially available and, when configured together, provide a resulting force that is of a magnitude that is suitable for propelling vehicles to a very high velocity, for example eventually approaching close to the speed of light.

1. A vehicle (100) comprising a propulsion arrangement, wherein the propulsion arrangement includes a chamber arrangement that is configured to store antimatter therein by using magnetic and/or electrostatic fields, wherein the chamber arrangement and a centre of gravity of the vehicle are positioned at a relative distance from each other to form a matter-antimatter dipole when in operation, and wherein the matter-antimatter dipole provides a propulsion force to the vehicle, wherein the chamber arrangement includes
an apparatus (1100) for generating a propulsion force, wherein the apparatus (1100) includes:
a laser arrangement (1110) for generating photons;
an optical device (1120; 1200, 1210A, 1210B) including an optical region for spatially separating at least a portion of the photons into corresponding electrons and positrons;
a coupling arrangement for coupling the positrons and electrons into respective corresponding coils of optical fibre (1410A, 1410B);
wherein the optical device (1120; 1200, 1210A, 1210B) and the coils (1410A, 1410B) preserve a coherence of photons as they propagate in use around the coils (1410A, 1410B);
wherein the coils (1410A; 1410B) are disposed to be spatially mutually spaced apart or only partially spatially overlapping, for the electrons and positrons to generate a matter-antimatter dipole for generating the propulsion force; and
wherein the optical region of the optical device (1120; 1200, 1210A, 1210B) is configured to exhibit in use a non-linear optical effect for spatially separating the at least a portion of the photons into the corresponding electrons and positrons.

2. The vehicle (100) of claim 1, wherein the apparatus (1100) is configured for the optical region to include one or more optical materials for use in generating the non-linear optical effect, wherein the one or more optical materials include at least one of: Lithium Niobate, Copper-doped Lithium Niobate Lithium-Niobate-On-Insulator, Barium Titanate, Barium Niobate, Graphene, doped Graphene, n-doped optically-transmissive material, p-doped optically-transmissive material.

3. The vehicle (100) of claim 1, wherein the apparatus (1100) is configured for the optical region to include at least two waveguides (1210A, 1210B) that are mutually spatially disposed on at least one substrate (1200) to support spatial segregation of the one or more electrons and the one or more positrons to generate the one or more corresponding matter-antimatter dipoles, and to maintain coherence of the one or more photons giving rise the one or more matter-antimatter dipoles as they propagate within the operating region and the coils (1410A, 1410B).

4. The vehicle (100) of claim 1, wherein the apparatus (1100) is configured for the optical device (1120; 1200, 1210A, 1210B) to be configured to selectively propagate photons of Bloch modes, more optionally Floquet-Bloch modes.

5. The vehicle (100) of claim 1, the apparatus (1100) is configured to operate the laser arrangement (1100) in a pulsed mode to generate the photons in pulses.

6. The vehicle (100) of claim 1, wherein the chamber arrangement is configured to be angularly adjustable with respect to the centre of gravity of the vehicle for steering the vehicle.

7. A method for propelling a vehicle (100) comprising a propulsion arrangement, wherein the method includes:
(i) arranging for the propulsion arrangement to include a chamber arrangement;
(ii) configuring the chamber arrangement to store antimatter therein by using magnetic and/or electrostatic fields; and
(iii) arranging for the chamber arrangement and a centre of gravity of the vehicle to be positioned at a relative distance from each other to form a matter-antimatter dipole when in operation, wherein the matter-antimatter dipole provides a propulsion force to the vehicle,
wherein the chamber arrangement includes an apparatus (1100) for generating a propulsion force, wherein the apparatus (1100) includes:
a laser arrangement (1110) for generating photons;
an optical device (1120; 1200, 1210A, 1210B) including an optical region for spatially separating at least a portion of the photons into corresponding electrons and positrons;
a coupling arrangement for coupling the positrons and electrons into respective corresponding coils of optical fibre (1410A, 1410B);
wherein the optical device (1120; 1200, 1210A, 1210B) and the coils (1410A, 1410B) preserve a coherence of photons as they propagate in use around the coils (1410A, 1410B);
wherein the coils (1410A; 1410B) are disposed to be spatially mutually spaced apart or only partially spatially overlapping, for the electrons and positrons to generate a matter-antimatter dipole for generating the propulsion force; and
wherein the optical region of the optical device (1120; 1200, 1210A, 1210B) is configured to exhibit in use a non-linear optical effect for spatially separating the at least a portion of the photons into the corresponding electrons and positrons.

8. An apparatus (1100) for generating a propulsion force, wherein the apparatus (1100) includes:
a laser arrangement (1110) for generating photons;
an optical device (1120; 1200, 1210A, 1210B) including an optical region for spatially separating at least a portion of the photons into corresponding electrons and positrons;
a coupling arrangement for coupling the positrons and electrons into respective corresponding coils of optical fibre (1410A, 1410B);
wherein the optical device (1120; 1200, 1210A, 1210B) and the coils (1410A, 1410B) preserve a coherence of photons as they propagate in use around the coils (1410A, 1410B);
wherein the coils (1410A; 1410B) are disposed to be spatially mutually spaced apart or only partially spatially overlapping, for the electrons and positrons to generate a matter-antimatter dipole for generating the propulsion force; and
wherein the optical region of the optical device (1120; 1200, 1210A, 1210B) is configured to exhibit in use a non-linear optical effect for spatially separating the at least a portion of the photons into the corresponding electrons and positrons.

9. The apparatus (1100) of claim 8, wherein the optical region includes one or more optical materials for use in generating the non-linear optical effect, wherein the one or more optical materials include at least one of: Lithium Niobate, Copper-doped Lithium Niobate Lithium-Niobate-On-Insulator, Barium Titanate, Barium Niobate, Graphene, doped Graphene, n-doped optically-transmissive material, p-doped optically-transmissive material.

10. The apparatus (1100) of claim 8, wherein the optical region is supported by at least one substrate (1200) that includes a dielectric material,
wherein the dielectric material of the at least one substrate (1200) includes at least one of: Silicon, silica, quartz, sapphire,
wherein the at least one substrate (1200) includes a dielectric layer formed onto a bulk Silicon substrate, wherein the operating region is fabricated onto the dielectric layer, remote from the Silicon substrate,
an energy collection arrangement for extracting energy, wherein the energy collection arrangement includes one or more electrodes (1270, 1280) configured to have their elongate axes substantially parallel or in a curved formation in the optical region to collect electrons therefrom arising from the one or more antimatter-matter dipoles, wherein the one or more electrodes (1270, 1280) are configured to be included within a spatial extent of wavefunctions of photons propagating in the optical region,
wherein the apparatus (1100) is configured to provide at least a portion of the extracted energy to the laser arrangement (1110), for example to assist to energize the laser arrangement (1110),
wherein the optical region includes one or more optical materials for use in generating the non-linear optical effect, wherein the one or more optical materials include a zero band-gap material, and
wherein the energy converter is configured to provide at least a portion of the extracted energy, for example from the one or more electrodes, to the laser arrangement.

11. The apparatus (1100) of claim 8, wherein the optical region includes at least two waveguides (1210A, 1210B) that are mutually spatially disposed on the at least one substrate (1200) to support spatial segregation of the one or more electrons and the one or more positrons to generate the one or more corresponding matter-antimatter dipoles, and to maintain coherence of the one or more photons giving rise the one or more matter-antimatter dipoles as they propagate within the operating region and the coils (1410A, 1410B).

12. The apparatus (1100) of claim 8, wherein the optical device (1120; 1200, 1210A, 1210B) is configured to selectively propagate photons of Bloch modes, more optionally Floquet-Bloch modes.

13. The apparatus (1100) of claim 8, wherein the apparatus (1100) is configured to operate the laser arrangement (1100) in a pulsed mode to generate the photons in pulses.

14. A method (1700) for operating an apparatus (1100) for generating a propulsion force, wherein the method (1700) includes:
configuring a laser arrangement (1110) of the apparatus (1100) to generate photons;
configuring an optical device (1120; 1200, 1210A, 1210B) of the apparatus (1100) to include an optical region to spatially separate at least a portion of the photons into corresponding electrons and positrons;
configuring a coupling arrangement of the apparatus (1100) to couple the at least a portion of positrons and electrons into respective corresponding coils of optical fibre (1410A, 1410B);
wherein the method (1700) further includes:
configuring the optical device (1120; 1200, 1210A, 1210B) and the coils (1410A, 1410B) to preserve a coherence of the photons as they propagate in use around the coils (1410A, 1410B);
configuring the coils (1410A; 1410B) to be disposed to be spatially mutually spaced apart or only partially spatially overlapping, for the electrons and positrons to generate a matter-antimatter dipole for generating the propulsion force; and
configuring the optical region of the optical device (1120; 1200, 1210A, 1210B) to exhibit in use a non-linear optical effect for spatially separating the at least a portion of the photons into the corresponding electrons and positrons.

15. A software product stored on a machine-readable data carrier, wherein the software product is executable on computing hardware (1750) and is configured to:
configuring a laser arrangement (1110) of the apparatus (1100) to generate photons;
configuring an optical device (1120; 1200, 1210A, 1210B) of the apparatus (1100) to include an optical region to spatially separate at least a portion of the photons into corresponding electrons and positrons;
configuring a coupling arrangement of the apparatus (1100) to couple the at least a portion of positrons and electrons into respective corresponding coils of optical fibre (1410A, 1410B);
wherein the method (1700) further includes:
configuring the optical device (1120; 1200, 1210A, 1210B) and the coils (1410A, 1410B) to preserve a coherence of the photons as they propagate in use around the coils (1410A, 1410B);
configuring the coils (1410A; 1410B) to be disposed to be spatially mutually spaced apart or only partially spatially overlapping, for the electrons and positrons to generate a matter-antimatter dipole for generating the propulsion force; and
configuring the optical region of the optical device (1120; 1200, 1210A, 1210B) to exhibit in use a non-linear optical effect for spatially separating the at least a portion of the photons into the corresponding electrons and positrons.

16. An energy converter (1110, 1120, 1200) for generating an output signal, wherein the energy converter includes:
a laser arrangement (1110) for generating photons;
an optical device (1200) including an optical region for spatially separating at least a portion of the photons into corresponding electrons and positrons, to generate matter-antimatter dipoles in the optical region;
an energy collection arrangement (1270, 1320) for coupling to the matter-antimatter dipoles to generate the output signal,
wherein the optical region of the optical device is configured to exhibit in use a non-linear optical effect for spatially separating the at least a portion of the photons into the corresponding electrons and positrons.

17. An energy converter (1110, 1120, 1200) of claim 16, wherein the non-linear optical effect includes an optical Kerr effect that causes spatial separation of the photons into their corresponding electrons and positrons.

18. The energy converter (1110, 1120, 1200) of claim 16, wherein the energy converter (1110, 1120, 1200) is configured to function as an optical system having optical dispersion characteristics that include at least two optical dispersion states, wherein one of the dispersion states is arranged to have an enhanced electron occupation, and wherein another of the dispersion states is arranged to have an enhanced positron occupation, thereby enabling to form a matter-antimatter dipole.

19. The energy converter (1110, 1120, 1200) of claim 16, wherein the optical region includes one or more optical materials for use in generating the non-linear optical effect, wherein the one or more optical materials optionally include at least one of: Lithium Niobate, Copper-doped Lithium Niobate, Lithium-Niobate-On-Insulator (LNOI, TFLN), Barium Titanate, Barium Niobate, Graphene, doped Graphene, n-doped optically-transmissive material, p-doped optically-transmissive material.

20. The energy converter (1110, 1120, 1200) of claim 16, wherein the optical region includes at least two waveguides that are mutually spatially disposed on the at least one substrate to support spatial segregation of the one or more electrons and the one or more positrons to generate the one or more corresponding matter-antimatter dipoles, and to maintain coherence of the one or more photons giving rise the one or more matter-antimatter dipoles as they propagate within the optical region, wherein the at least two waveguides are configured to exhibit, when in use, optical dispersion characteristics including at least two optical dispersion states, wherein one of the dispersion states is arranged to have an enhanced electron occupation, and wherein another of the dispersion states is arranged to have an enhanced positron occupation, thereby enabling a matter-antimatter dipole to be formed.

21. The energy converter (1110, 1120, 1200) of claim 16, wherein the optical device is configured to selectively propagate photons of Bloch modes, optionally Floquet-Bloch modes.

22. The energy converter (1110, 1120, 1200) of claim 16, wherein the energy converter further includes an energy collection arrangement for extracting energy, wherein the energy collection arrangement includes one or more electrodes configured to have their elongate axes substantially parallel or in a curved formation in the optical region to collect electrons therefrom arising from the one or more antimatter-matter dipoles formed therein, wherein the one or more electrodes are configured to be included, at least in part, substantially within a spatial extent of wavefunctions of photons propagating in the optical region.

23. The energy converter (1110, 1120, 1200) of claim 22, wherein the laser arrangement (1110) is configured to be operated in a pulsed mode, wherein electron and positron charge concentrations arising momentarily in operation in the at least two waveguides are Coulombically capacitively coupled to the one or more electrodes, giving rise to the output signal.

24. The energy converter (1110, 1120, 1200) of claim 16, wherein the energy converter (1110, 1120, 1200) is configured to operate the laser arrangement in a pulsed mode to generate the photons in pulses.

25. A method of using an energy converter (1110, 1120, 1200) for generating an output signal, wherein the method includes:
using a laser arrangement (1110) of the energy converter for generating photons;
using an optical device (1200) of the energy converter, wherein the optical device (1200) includes an optical region, for spatially separating at least a portion of the photons into corresponding electrons and positrons, to generate matter-antimatter dipoles in the optical region;
using an energy collection arrangement (1270, 1320) of the energy converter for coupling to the matter-antimatter dipoles to generate the output signal,
wherein the optical region of the optical device (1200) is configured to exhibit in use a non-linear optical effect for spatially separating the at least a portion of the photons into the corresponding electrons and positrons.
